(19) United States
(12) Patent Application Publication
(10) Pub. No.: US 2007/0220120 A1
(43) Pub. Date: Sep. 20, 2007

(54) Computer System

(76) Inventors: Takashi Tsunehiro, Kawasaki (JP); Takatoshi Kato, Kawasaki (JP); Kazushi Nakagawa, Kawasaki (JP); Makoto Kayashima, Kawasaki (JP); Shinji Kimura, Kawasaki (JP); Ikuko Kobayashi, Kawasaki (JP)

Correspondence Address: MCDERMOTT WILL & EMERY LLP, 600 13TH STREET, N.W., WASHINGTON, DC, 20005-3096, US

(21) Appl. No.: 10/564,467

(22) PCT Filed: Jan. 28, 2005
(86) PCT No.: PCT/JP05/01239

§ 371 Date: Jan. 8, 2007

(30) Foreign Application Priority Data
Apr. 12, 2004 (JP) 2004-116334
Jul. 21, 2004 (JP) 2004-212459

(51) Int. Cl. G06F 15/177

(52) U.S. Cl. 709/220

(57) ABSTRACT

A computer system can always execute processing under the same environments not depending on the terminal device that is directly used by the user, no matter where the client used by the user is, and no matter what device is used. In the computer system, one of plural computer PCBAs that do not install a hard disk device therein is selected from the terminal device, remotely controllable environments are constituted, and data is read and written from the hard disk device which are coupled to all of the computer PCBAs over a network that is used by the user.

### FIELD OF THE INVENTION

The present invention relates to a computer system in which storage device such as a hard disk device is used by a user over a network, and more particularly to a technique by which the computer system is collectively managed, and the user uses the computer system from a device coupled over the network.

### DESCRIPTION OF THE RELATED ART

In recent years, the price reductions of a personal computer (hereinafter referred to as “PC”) and network devices have been advanced, and business enterprises that distribute devices such as the PCs to most of employees for conducting application are being increased in number. As the business enterprises purchase an increased number of PCs with the price reduction in the PC, the number of PCs that must be subjected to maintenance operation by a device manager within the business enterprise is increased in proportion. In the present specification, the maintenance operation is directed to, for example, version up or bug fix of an operating system (hereinafter referred to as “OS”) or a business application, a response to a hardware failure, antivirus or safeguard against virus. Since the management costs expended for the maintenance operation are very high, the management costs become more immense in proportion as the number of employees who use the PCs is more increased.

As a manner for reducing the management costs, there is a system operating method that is called “server client system”. In the system, main program or data which is used by the user is stored in a computer that is called “server”, to reduce data that is stored in a computer (hereinafter also referred to as “client”) operated directly by the user, which is called, for example, “thin client” (for example, refer to Japanese Patent Laid-Open No. 2004-094411).

In the server client system, because an operation process and the storage of data are mainly conducted by the server, there is reduced the necessity or frequency of conducting the version up or bug fix of the OS or the application used for business, antivirus or the safeguard against virus by a client, individually. For that reason, the total management costs can be reduced.

Also, as a method of easing the enlargement of the server scale with an increase in the number of users who use the above server, there is a method that is called “blade server”. This constitutes a computer in which a CPU and a memory are mounted on a single printed circuit board which is called “blade style computer”.

The single blade is used as one server, and when the number of users increases, the number of blades is increased to disperse the load.

### SUMMARY OF THE INVENTION

In the above server client system, all of the users who use the server through the clients are required to commonly use the same application program on the server, and it is difficult to constitute different applications or environments on the same server by the individual users. For that reason, it is usual to execute the applications that must be processed by each of the users at the client side that is used by each of the users. There is no case in which the applications that must be processed by each of the users are not installed at the server side. Thus, the client server system is improper in conducting the operation under the environments that are changed by the users, individually. Accordingly, there is no advantage except that the data is stored in a storage device at the server side, and the backup management is collectively managed, if anywhere. Also, in the server client system, the client that is always used by each of the users is fixed, and it is difficult to recreate the environments of a computer which the user wishes to use at a different location (different client).

The present invention has been made to solve the above problems with the related art, and therefore an object of the present invention is to provide a computer system which can always execute processing under the same environments no matter where the client used by the user is, and no matter what device is used.

The above object, other objects and novel features of the present invention will become apparent from the description f the present invention and the attached drawings.

The summary of the present invention will be described below. That is, in order to achieve the above object, a computer system according to the present invention is structured in such a manner that a plurality of blade style computers is coupled to a storage device over a network. A user employs that blade style computer over the network as a computer that can freely set the environments and applications by each of the users with the use of an arbitrary client (hereinafter also referred to as “terminal device”). More specifically, the blade style computer that is used by the user access to OS or data by using a storage device having a storage area that has been allocated by the respective users over the network. For achieving the above access, the blade style computers are coupled to the storage device through not a hard disk dedicate interface but a network communication interface. Any of the plural blade style computers which should be used by the user is selected on the basis of a given rule by the management computer, and notified the user of. The management computer manages information on a correspondence of a storage area of the storage device to the user who uses the storage area, and notifies the blade style computers which are used by the user of the information on the storage area corresponding to the user.

According to the present invention, the same OS or application can be executed under the same setting situation even if the connection situation is changed, not depending on the client that is used by the user. Accordingly, there can be provided a computer system that improves the convenience of the user and reduces the device costs and the management costs of the manager.

These and other objects and many of the attendant advantages of the invention will be readily appreciated as the same becomes better understood by reference to the following detailed description when considered in connection with the accompanying drawings.

### BRIEF DESCRIPTION OF THE DRAWINGS

FIG. 1 is a structural block diagram for entirely explaining a first embodiment of the present invention;

FIG. 2 is a structural block diagram for explaining a computer Printed Circuit Board Assembly (In the following, it is abbreviated as PCBA) according to the first embodiment;

FIG. 3 is a diagram showing a table;

FIG. 4 a diagram showing a hibernated user list;

FIG. 5 is a diagram showing a user used area list;

FIG. 6 is a diagram showing a logic structure of a hard disk device;

FIG. 7 is a structural block diagram for entirely explaining a second embodiment of the present invention;

FIG. 8 is a structural block diagram for explaining a computer PCBA according to the second embodiment;

FIG. 9 is a structural block diagram for entirely explaining a third embodiment of the present invention;

FIG. 10 is a structural block diagram for entirely explaining a fourth embodiment of the present invention;

FIG. 11 is a structural block diagram for explaining a terminal device and a remote terminal device;

FIG. 12 is a structural block diagram for entirely explaining a fifth embodiment of the present invention;

FIG. 13 is a structural block diagram for entirely explaining a sixth embodiment of the present invention;

FIG. 14 is a flowchart showing a basic start procedure;

FIG. 15 is a flowchart showing a procedure of stopping the terminal device;

FIG. 16 is a flowchart showing a procedure of resuming the terminal device;

FIG. 17 is a flowchart showing a procedure of setting a computer PCBA to a standby mode;

FIG. 18 is a flowchart showing a procedure of returning the computer PCBA from the standby mode;

FIG. 19 is a flowchart showing a procedure of setting the computer PCBA to a hibernation mode;

FIG. 20 is a flowchart showing a procedure of returning the computer PCBA from the hibernation mode;

FIG. 21 is a diagram showing a structural example of an certification device;

FIG. 22 is a diagram showing an example of a user authentication procedure by using the certification device;

FIG. 23 is a structural block diagram for entirely explaining a seventh embodiment of the present invention;

FIG. 24 is a diagram showing an access management list;

FIG. 25 is a flowchart showing a procedure in the case of using a storage device including an access right determination unit therein;

FIG. 26 is a structural block diagram for entirely explaining an eighth embodiment of the present invention;

FIG. 27 is a diagram showing a table;

FIG. 28 is a diagram showing a PCBA network table;

FIG. 29 is a flowchart showing a procedure in the case of using a PCBA management computer;

FIG. 30 is a structural block diagram for entirely explaining a ninth embodiment of the present invention;

FIG. 31 is a diagram showing a conversion address table;

FIG. 32 is a flowchart showing a procedure in the case of using an application gateway device; and

FIG. 33 is a flowchart showing a procedure in the case of using the certification device.

### DETAILED DESCRIPTION OF THE PREFERRED EMBODIMENTS

Now, a description will be given in more detail of preferred embodiments of the present invention with reference to the accompanying drawings. In the drawings, the same reference numerals denote identical structural elements, and therefore their duplicate detailed description will be omitted for convenience of description.

### First Embodiment

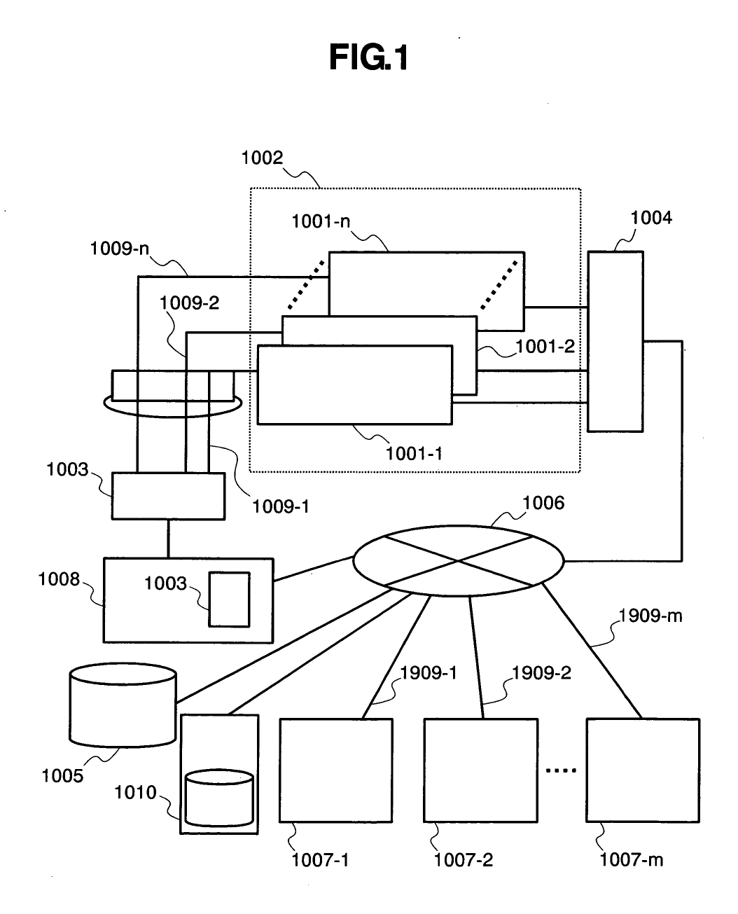

FIG. 1 is a diagram showing an example of a computer system according to a first embodiment of the present invention.

A user uses one arbitrary terminal among terminal devices (1007-1 to 1007-m). The terminal devices 1007 are coupled to a network 1006 through network wirings (1909-1 to 1909-m), respectively. The network 1006 is also coupled to a management computer 1008 and a hub device 1004. The user selects one or plural computer PCBAs from a computer device 1002 consisting of n computer PCBAs (1001-1 to 1001-n: corresponding to the blade style computers) for use. The management computer 1008 selects any of the computer PCBAs 1001 according to a predetermined rule, and then instructs the selected computer PCBA to the terminal devices 1007. Alternatively, it is possible that the user per se directly instructs any of the computer PCBAs to be used to the management computer 1008. In order to start the computer PCBA 1001 that has been selected according to the rule or the instruction, the management computer 1008 instructs a power control mechanism 1003 to start the computer PCBA 1001. The power control mechanism 1003 supplies a power to a power line (1009-1 to 1009-n) corresponding to the instructed computer PCBA 1001 to start the computer PCBA 1001. For example, in the case where the computer PCBA 1001-1 is selected, the power control mechanism 1003 supplies a power to a power supply 1009-1.

The above rule maybe defined as follows: For example, the user selects a computer PCBA which most matches a condition that is designated in advance (performance, memory capacity), 1 selects a computer PCBA that is lower in the frequency of use, saves the use history of the computer PCBA by the user and preferentially selects a computer PCBA which has been used by the user with reference to the use history, selects the computer PCBA at random, and selects a computer PCBA that is the highest in performance from the computer PCBAs that have not yet been used. Also, the computer PCBA may be selected in each of groups such as a department or a section to which the user belongs. For example, the executive officer's computer PCBAs are distinguished from another group, or if a shared server of the department is provided, the computer PCBA is selected from the group that can access to the department server. In this case, information on the respective groups (information on the users who belongs to the respective groups) is managed by the management computer 1008 with the use of a table. In addition, it is possible that dates of manufacture of the computer PCBAs are managed, and the oldest (or newest) computer PCBA is selected from unused computer PCBAs.

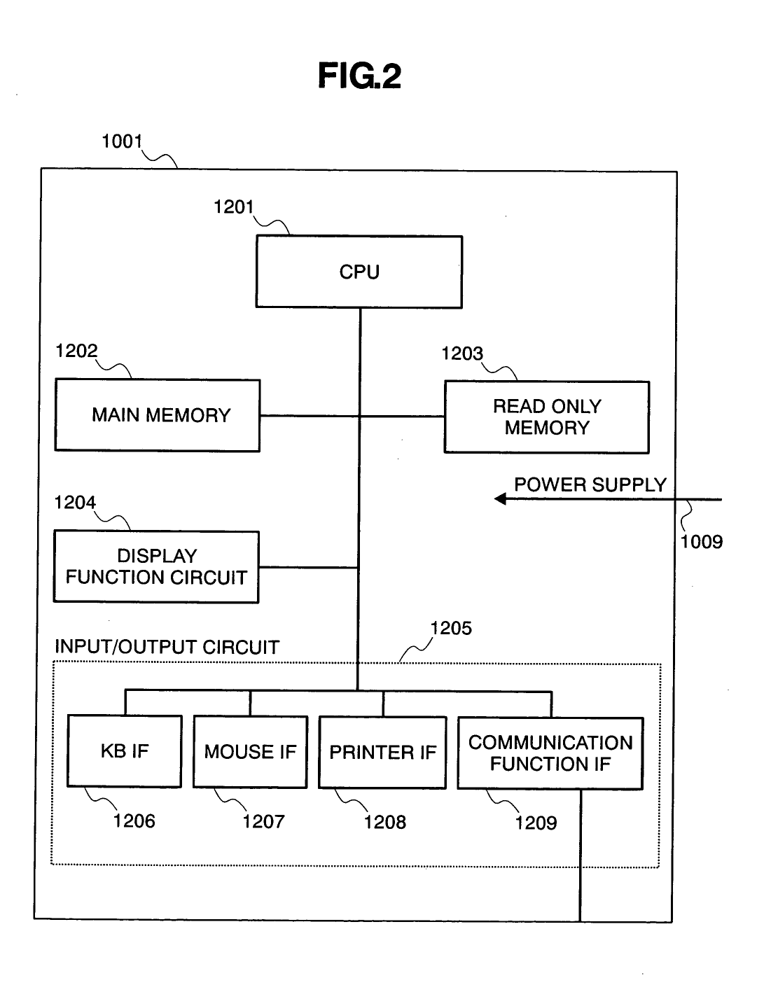

FIG. 2 is a diagram showing one structural example of the computer PCBA 1001. The computer PCBA 1001 includes a CPU 1201, a main storage memory 1202, a read only memory 1203, a display function circuit 1204, and an input/output circuit 1205, which are mutually coupled to each other through a bus. Also, the input/output circuit 1205 includes a keyboard interface 1206, a mouse interface 1207, a printer interface 1208, and a communication function interface 1209. However, a hard disk device that is equipped in an ordinary computer is not included in the computer PCBA 1001. When an electric power is supplied to the power line 1009 corresponding to the computer PCBA 1001, the CPU 1201 reads an initial start software (BIOS: basic input/output system) from the read only memory 1203 to execute the software. Thereafter, the operation of starting the OS per se is conducted according to an instruction from the BIOS. In this situation, the software body of the OS is read from the hard disk device 1005 through the communication function interface 1209. The communication function interfaces 1209 of the respective PCBAs are collected by the hub device 1004, and then coupled to the network 1006. The network 1006 is coupled to the hard disk device 1005.

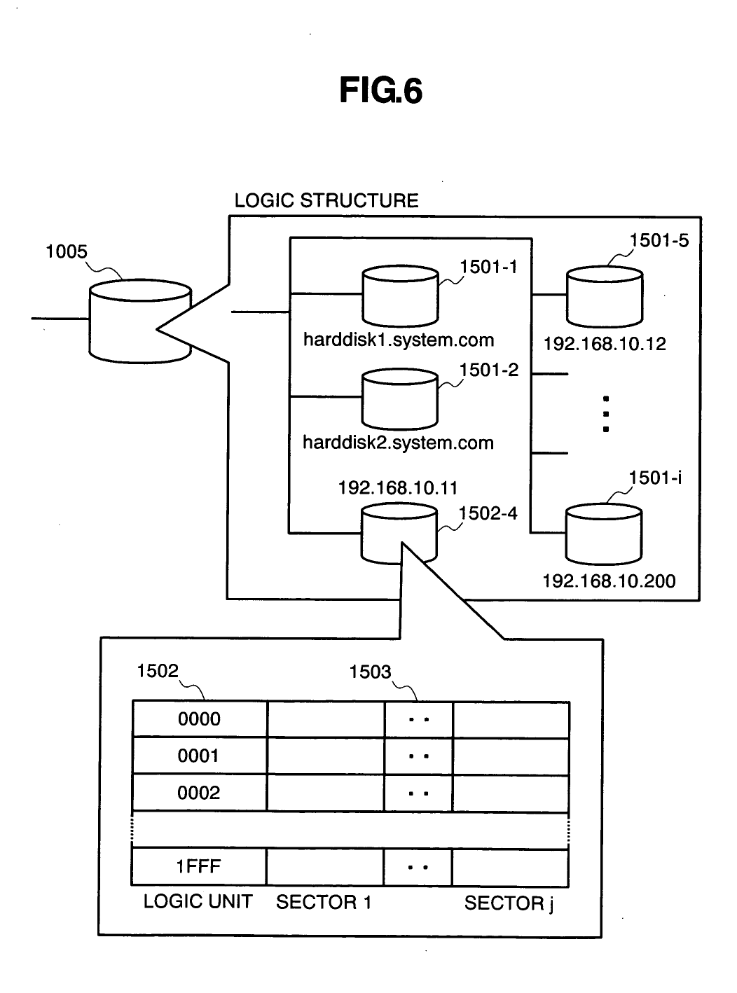

FIG. 6 is a diagram showing a structural example of the hard disk device 1005. The hard disk device 1005 may be made up of one disk device or an aggregative hard disk device for example, RAID device) that combines plural disk devices together. In FIG. 6, the hard disk device 1005 is formed of the aggregative disk device which includes independent hard disk devices (1501-1 to 1501-i) and a control unit that controls those hard disk devices (1501-1 to 1501-i). The storage area of the respective hard disk devices 1501 is divided on the basis of a logical unit No. 1502. The storage area of the respective logical units is divided into sectors 1 to j.

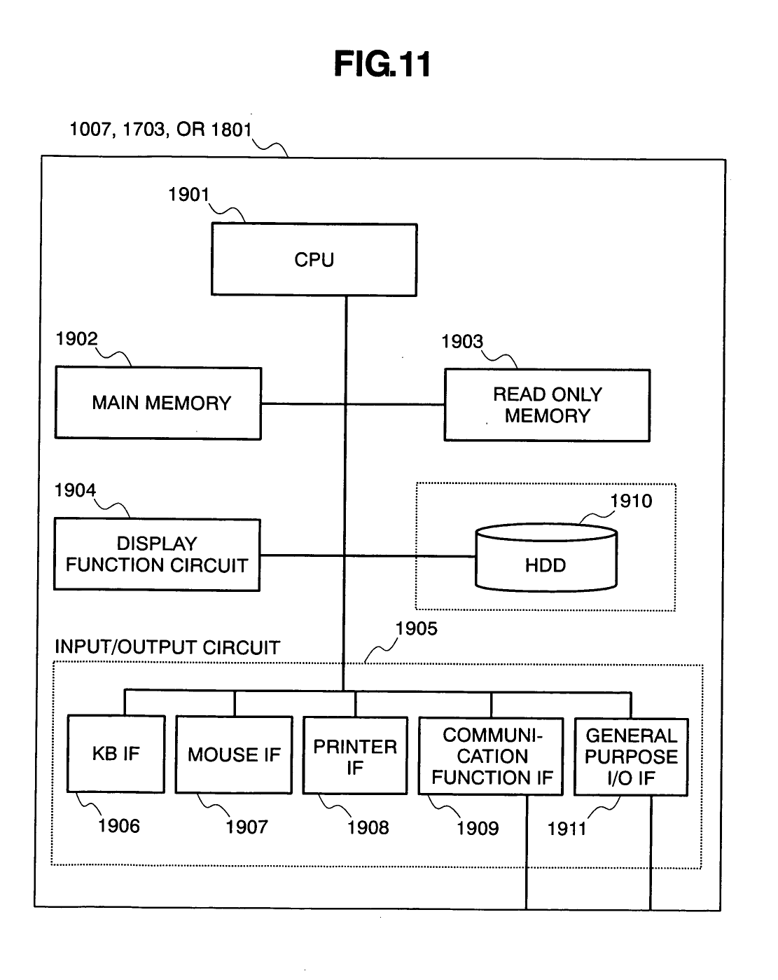

FIG. 11 is a diagram showing a structural example of the terminal device 1007. The terminal device 1007 has a 1901, a main storage memory 1902, a read only memory 1903, a display function circuit 1904, and an input/output circuit 1905 mutually coupled to each other via a bus. Also, the input/output circuit 1905 includes a keyboard interface 1906, a mouse interface 1907, a printer interface 1908, a communication function IF 1909, and a general purpose I0 interface 1911. In addition, the input/output circuit 1905 may include a hard disk device 1910 which is not built in the computer PCBA 1001. Start of the respective elements may be conducted from the read only memory 1903 or an external storage device through the general purpose I0 interface 1911.

Other devices (management computer 1008, etc.) may be formed of ordinary computers.

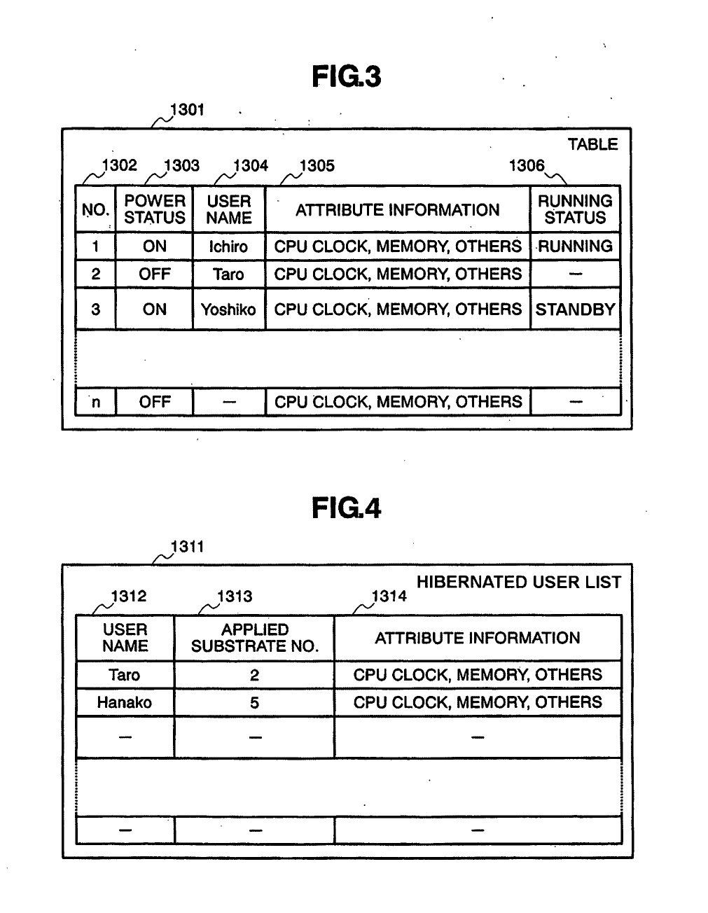

FIG. 3 is a diagram showing an example of a table 1301 that is stored in the management computer 1008. In the table, the power status 1303, the user name 1304 that uses the computer PCBA, the attribution information 1305 of the PCBA, and the running status 1306 are stored by the number of computer PCBAs 1001 provided in the computer device 1002 in correspondence with No. 1302 of the computer PCBA 1001. The “standby” described in the running status 1306 means a standby mode. The standby mode is directed to a mode in which the operation clock of the CPU 1201 is lowered, or a refresh rate of the main storage memory 1202 is delayed to reduce the power consumption of the PCBA per se. In the standby mode, the user cannot conduct the usual application process, but can resume the process in the computer PCBA 1001 simpler than a case in which a power is perfectly shut off.

As the attribution information 1305 on the PCBA, there are stored the performance or specification of the CPU 1201, the memories 1202 and 1203, and the display function PCBA 1001, a settable range of set numeric values, and a setting enable/disenable information of the power management, which are setting information provided by the computer PCBA 1001.

In the example of FIG. 3, there are recorded in the computer PCBA 1001-1 of No. 1 that the power is on-state, the user is Ichiro, there are attribution information describing the features of the PCBA, and the running status is on. In the PCBA of No. 2, the power is off, but Taro of the user name occupies the computer PCBA.

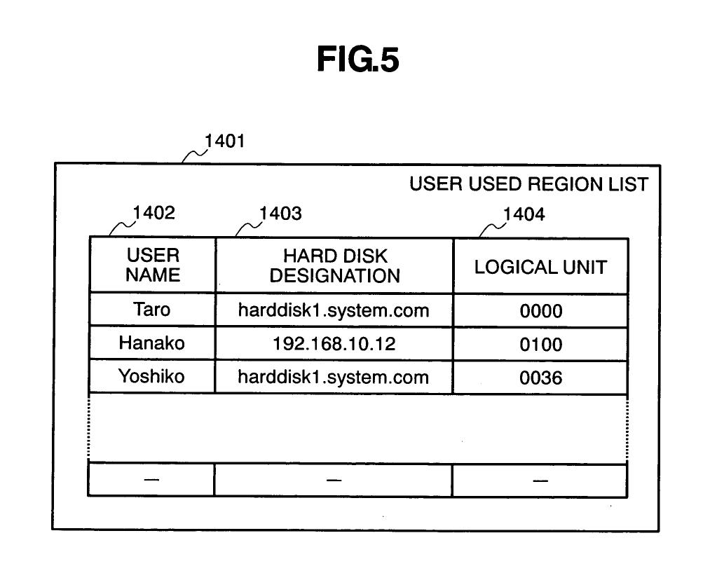

In the present specification, the “occupy” represents a state (hereinafter referred to as “hibernation”) in which the user stops the use of the computer PCBA, but does not waive the right to use the computer PCBA. Whether the user hibernates the use of a certain computer PCBA 1001, or not, is recorded in a hibernated user list 1311 as shown in FIG. 4. In general, there is a computer that can be set to a hibernation status (or “hibernation mode”) when the computer PCBA is not used for energy saving. The hibernation status is a state in which all of information on the running status of the computer is written in a nonvolatile storage medium such as a hard disk drive, and a power supply of the computer PCBA per se is turned off. In the hibernation status, the power consumption can be reduced more than the above-mentioned standby mode, but it takes much time to resume the processing in the computer PCBA.

Accordingly, even if the power supply of the computer PCBA 1001 is off, it is necessary to discriminate whether the computer PCBA is in a hibernation status, or in a state where the computer PCBA is not merely used. Therefore, the management computer 1008 manages the presence or absence of the hibernation of the computer PCBA with reference to the above-mentioned hibernated list 1311. In the hibernated user list 1311 are recorded the user name 1312, the hibernated PCBA No. 1313, and the attribute information 1314 on the PCBA.

When the management computer 1008 allocates the computer PCBA 1001 to a new user, the management computer 1008 selects the computer PCBA 1001 a power of which is off from the list 1301. In this situation, the management computer 1008 confirms from the hibernated user list 1311 whether the computer PCBA 1001 whose power is off is in hibernation, or not. Then, the management computer 1008 allocates the computer PCBA that is not in hibernation, that is, which is not used by any user to the new user.

On the other hand, when the user who is in hibernation requests the management computer 1008 to resume the computer PCBA which is in hibernation, the management computer 1008 confirms that there is a user name of the user who is a requester in the hibernated user list 1311. Then, the management computer 1008 specifies the computer PCBA 1001 that has been used by the user in correspondence with the user name, and instructs the resume to the computer device 1002. When the computer PCBA that had been used up to that time cannot be used (is failed), the management computer 1008 confirms the contents of the attribute information 1314 which has been registered in the hibernated user list 1311, and allocates another computer PCBA 1001 whose power is off and which has the same attribute information to resume.

The computer PCBA 1001 may be allocated in correspondence with a user identifier which is predetermined in each of the users.

In the case where another computer PCBA having the same attribute information is not allocated to the user, the management computer 1008 allocates an operable computer PCBA that is the nearest to the specification to the user. Specifically, the management computer 1008 first refers to the performance of the CPU among the attribute information, and then refers to the memory capacity to compare the specifications. Then, the management computer 1008 selects a computer PCBA that is close to the specification of the computer PCBA that cannot be resumed. As a result of allocation, in the case where the allocated computer PCBA does not normally operate due to a difference of parts such as the CPU, the memory and the network interface on the computer PCBA, the management computer 1008 holds the contents of the user list 1311 in a pre-allocated state. Then, the management computer 1008 interrupts the allocating operation until another PCBA having the same attribute information can be allocated to resume. The interrupt during the allocating operation is notified the user of, and the user selectively continuously waits for a chance at which the allocating operation can be executed, or cancels the request per se.

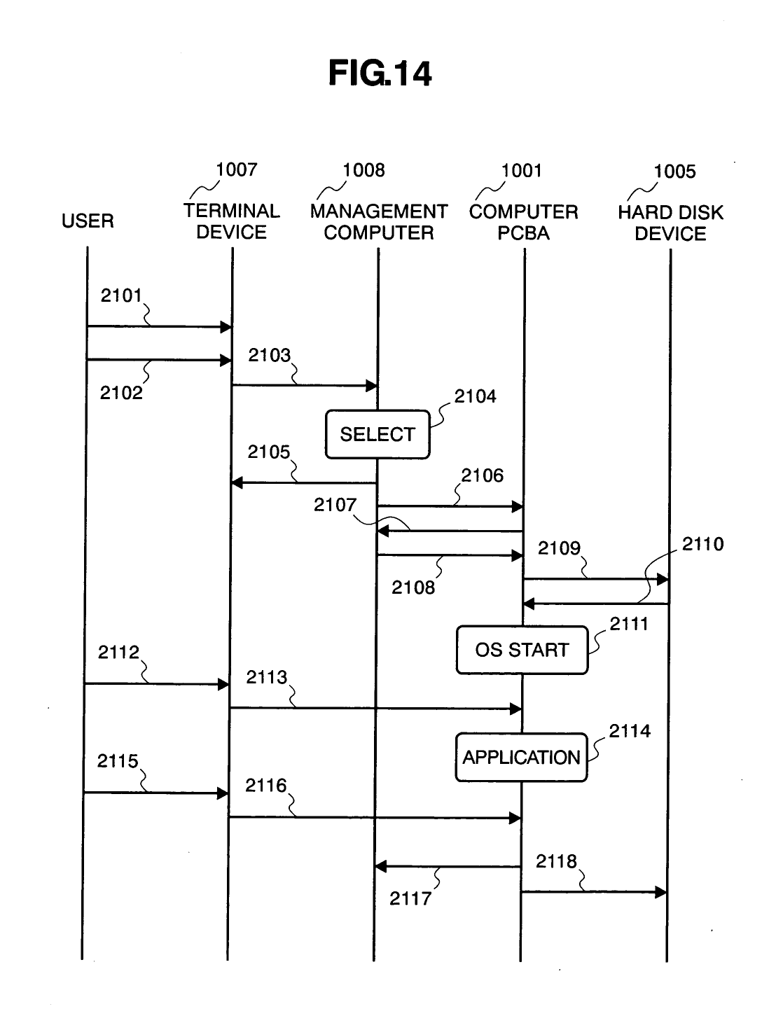

FIG. 14 is a flowchart showing a process until starting the computer PCBA 1001 in the computer system according to this embodiment. First, the user starts the terminal device 1007 (Step 2101). Thereafter, the user instructs the terminal device 1007 to start the computer PCBA 1001 (Step 2102). Upon receiving the instruction, the terminal device 1007 instructs the management computer 1008 to start the computer PCBA 1001 (Step 2103). Upon receiving the instruction, the management computer 1008 conducts a selecting process 2104. The selection process 2104 selects the computer PCBA 1001 to be used by the user on the basis of the predetermined rule and the information of the table 1301 and the hibernated user list 1311. After completion of the selecting process 2104, the management computer 1008 notifies the terminal device 1007 of the information on the determined computer PCBA 1001. In this situation, the management computer 1008 rewrites the running information in the table 1301 from unused to in-use (specifically, information on the user who uses the computer PCBA is registered) (Step 2105).

Thereafter, the management computer 1008 instructs the power control mechanism 1003 to turn on the power supply with respect to the selected computer PCBA 1001; The power control mechanism 1003 supplies a power to the power line 1009 corresponding to the selected computer PCBA 1001 (Step 2106). The computer PCBA 1001 whose power is turned on requests the management computer 1008 to send out the BIOS that is executed by the CPU 1201 in order to read out the OS over the network (Step 2107).

The management computer 1008 that receives the send-out request sends out the read-out BIOS to the computer PCBA 1001 according to that request. In this situation, the management computer 1008 notifies the computer PCBA 1001 of the information on the storage area of the hard disk device 1005 which is used by the user who starts the computer PCBA 1001 which receives the BIOS. In this situation, the management computer 1008 uses the user use area list 1401 shown in FIG. 5. The user use area list 1401 is information indicative of a correspondence between the user who uses the computer system and the storage area provided in the hard disk device 1005 which is used by the user. Specifically, information on the designation that is allocated to The hard disk device 1005 which is used by the user and logical unit No. indicative of the location of the storage area that is allocated to the user within the hard disk device 1005 is stored in each of the users. The management computer 1008 reads out the hard disk designation 1403 in which the data of the user exists with reference to the user name 1402, and also reads out the logical unit No. 1404 within the hard disk device 1005. The management computer 1008 sends out the hard disk designation 1403 and the logical unit No. 1404 to the computer PCBA 1001 together with the read-out BIOS (Step 2108).

The computer PCBA 1001 that has received the BIOS from the management computer 1008 executes the BIOS, and instructs the hard disk device 1005 over the network to read out the data (OS in this example) which is stored at an address indicated by the logical unit No. of the received hard disk device 1005 (Step 2109).

The hard disk device 1005 that has received the instruction sends out the OS that is stored in the storage area designated by the user to the computer PCBA 1001 according to the request (Step 2110).

The computer PCBA that has received the OS conducts the start process of the OS (Step 2111). When the computer PCBA 1001 requests the hard disk device 1005 to provide the data at the time of starting the computer PCBA 1001, the computer PCBA 1001 locates an area that is occupied by the user from the user use area list 1401 within the management computer 1008. The address and the size which are occupied by each of the users are described in the area. When the OS starts, and a situation in which the computer PCBA 1001 can be used by the business application is completed, the user conducts the application start process through the terminal device 1007 (Step 2112).

The terminal device 1007 instructs the starting computer PCBA 1001 to conduct the application start (Step 2113). Upon receiving the instruction, the computer PCBA 1001 conducts the application process (Step 2114). When the user completes the processing of the computer PCBA 1001, the user instructs the terminal device 1007 (Step 2115). The terminal device 1007 that has received the completion instruction instructs the computer PCBA 1001 to complete the process (Step 2116). The computer PCBA 1001 that has received the completion instruction starts the completion process, and also notifies the management computer 1008 of a process completion report. The management computer 1008 that has received the notification updates the running information of the table 1301 from in-use to unused with respect to the computer PCBA 1001 that has transmitted the notification (Step 2117). On the other hand, the computer PCBA 1001 that has started the completion process rewrites the data that has been used during the application process and stored in the own main storage memory 1202 back to the storage area of the hard disk device 1005 which is occupied by the user. After rewriting back, the computer PCBA 1001 stops itself. In this situation, the computer PCBA 1001 instructs the power control mechanism 1003 to stop the power supply (Step 2118).

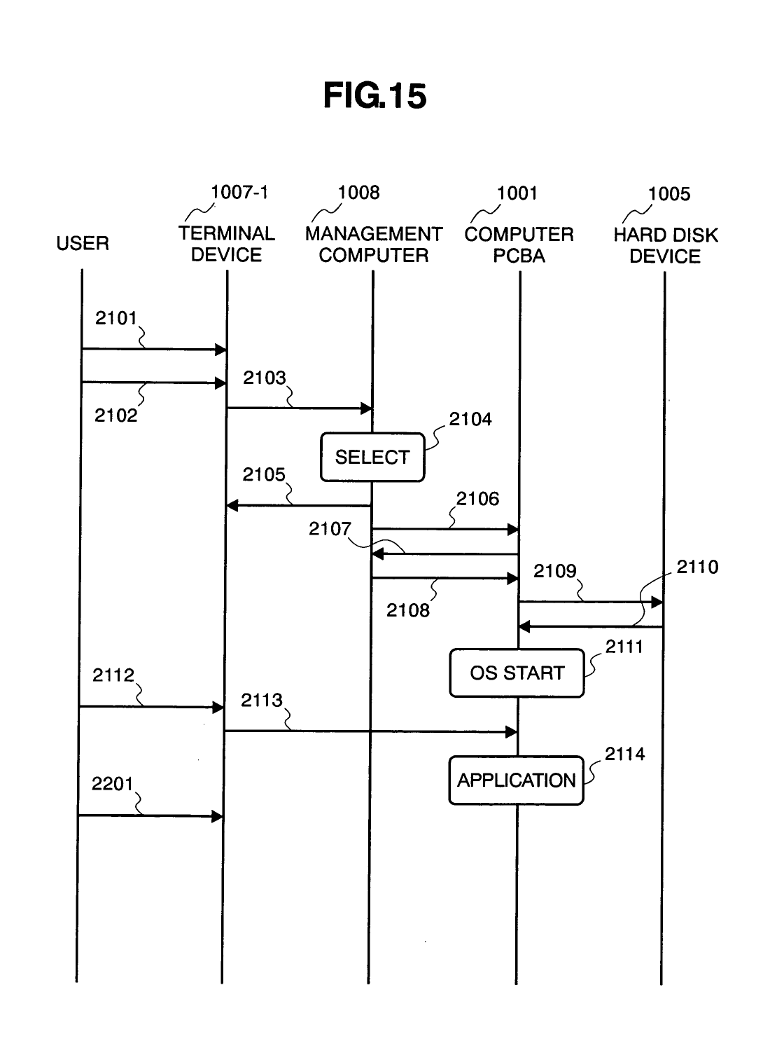

FIG. 15 is a diagram showing a procedure example in the case where the user gives an instruction to stop the terminal device 1007-1 (Step 2201) in a state where the computer PCBA 1001 executes the application process (Step 2114) in a procedure shown in FIG. 14. In this case, since the stop of the terminal device 1007 does not affect the process of the computer PCBA 1001, the computer terminal 1001 can continue the application process 2114. Then, in the case where the same user uses the computer device again by using another terminal device 1007, the management computer 1008 selects the computer PCBA 1001 that has been already in use, and notifies the terminal device 1007 that is used by the user of the information on the computer PCBA 1001 that is in use to resume the use.

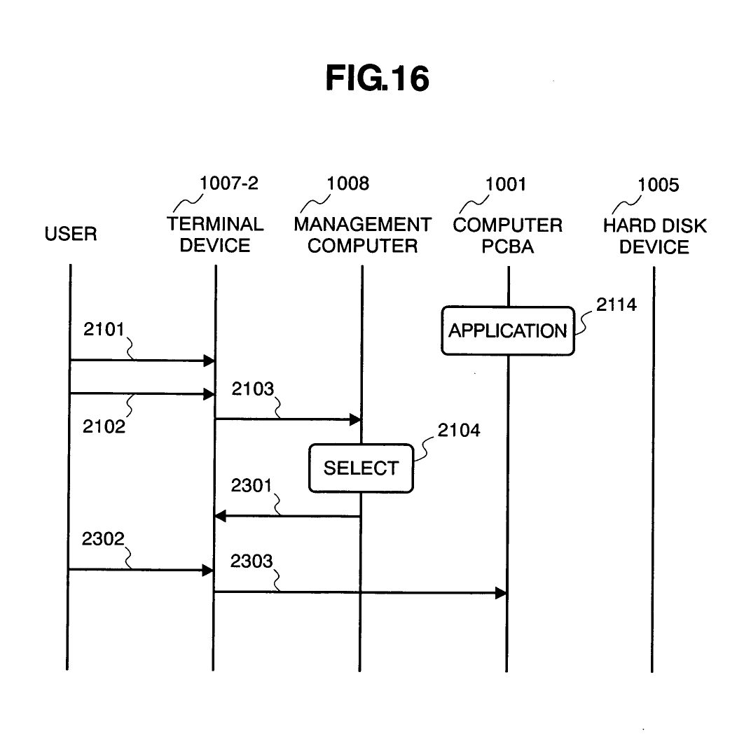

FIG. 16 is a diagram showing the details of the procedure example in the case where the user resumes the process in FIG. 15. The user starts another terminal device 1007-2, and requests the management computer 1008 to send the information on the computer PCBA 1001 (Step 2101). The management computer 1008 that has received the request selects the computer PCBA 1001. In this situation, since the computer PCBA that is used by the user has been already registered in the table 1301, the management computer 1008 selects the computer PCBA 1001 (Step 2104). Then, the management computer 1008 notifies the terminal device 1007-2 of the information on the computer PCBA that has been already used (Step 2301). Upon receiving this notification, the user instructs a new terminal device 1007-2 to conduct the application process (Step 2302), and gives a process instruction to the computer PCBA 1001 that had been used before from the terminal device 1007-2 (Step 2303) so as to continue the application.

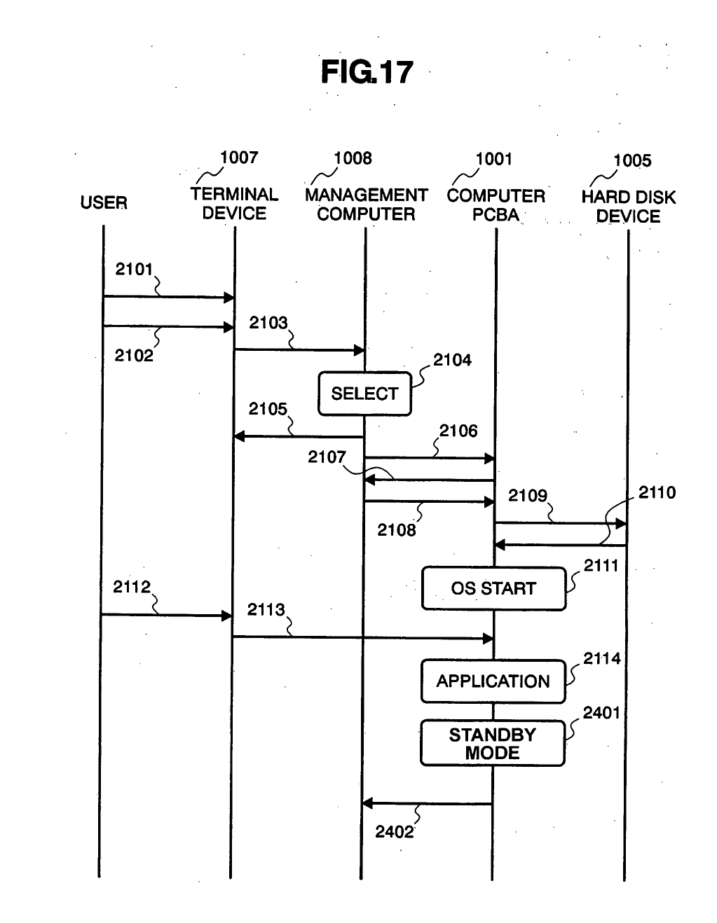

FIG. 17 is a diagram showing a procedure example in the case where the computer PCBA 1001 transits from the present mode to the standby mode while conducting the application process 2114. In the case where the computer PCBA 1001 transits to the standby mode, the computer PCBA 1001 conducts the storage process (Step 2401) of data necessary for the transition process to the standby mode on the main storage device 1202. Thereafter, the computer PCBA 1001 reports the entry of the standby mode to the management computer 1008 (Step 2402). The reported management computer 1008 rewrites the information on the running status in the table 1301 corresponding to the reporting computer PCBA 1001 to “standby”. The transition momentum to the standby mode has various cases such as a case where the CPU 1201 is not used for a given period of time.

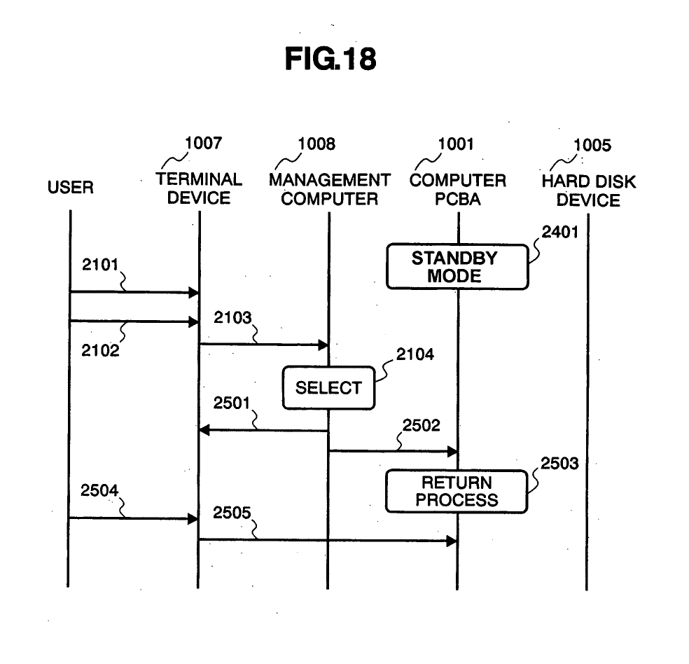

FIG. 18 is a diagram showing a procedure example in the case where the computer PCBA 1001 that has been set in the standby mode is returned to the original status. As in FIG. 14, the user starts the terminal device 1007, and requests the management computer 1008 to select the computer PCBA 1001 (Step 2101). The management computer 1008 selects the computer PCBA 1001, but the user selects the computer PCBA 1001 since the computer PCBA that is used in the table 1301 has been already registered (Step 2104). Then, the management computer 1008 notifies the terminal device 1007 of the information on the selected computer PCBA 1001. In this situation, the management computer 1008 changes the information on the running status of the table 1301 corresponding to the computer PCBA 1001 that instructs the return from the standby mode to “running” (Step 01).

Thereafter, the management computer 1008 instructs the computer PCBA 1001 that has been in the standby mode to execute the return process (Step 2502). The computer PCBA 1001 reads out the data necessary for returning from the main storage device 1202, and returns to a state which is before the computer PCBA 1001 has entered the standby mode (Step 2503). Upon return of the computer PCBA 1001, the user instructs the terminal device 1007 to conduct the application process (Step 2504), the terminal device 1007 gives a process instruction (Step 2505) to the computer PCBA 1001 that had been used before, and the computer PCBA 1001 resumes the application.

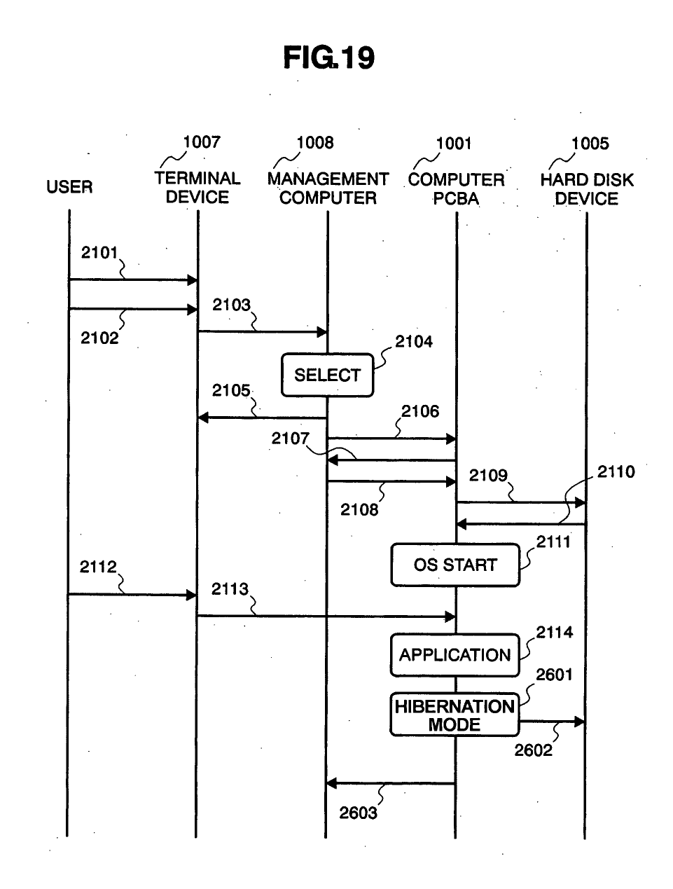

FIG. 19 is a diagram showing a procedure example in the case where the computer PCBA 1001 transits from the present mode to a hibernation mode while the computer PCBA 1001 is conducting the application process (Step 2114). When the computer PCBA 1001 transmits from the present mode to the hibernation mode, the computer PCBA 1001 writes all the information on the computer PCBA 1001 to the hard disk device 1005 (steps 2601 and 2602). Thereafter, the computer PCBA 1001 notifies the management computer 1008 of the entry of the hibernation mode. The notified management computer 1008 rewrites the information on the running status of the table 1301 corresponding to the notified computer PCBA 1001 to “hibernation”, and then registers the information on the user who had used the computer PCBA 1001 which has been shifted to the hibernation state in the hibernated user list 1311 (Step 2603). Thereafter, the computer PCBA 1001 notifies the power control mechanism 1003 of the shut-off of the power. As a result, the power consumption can be minimized.

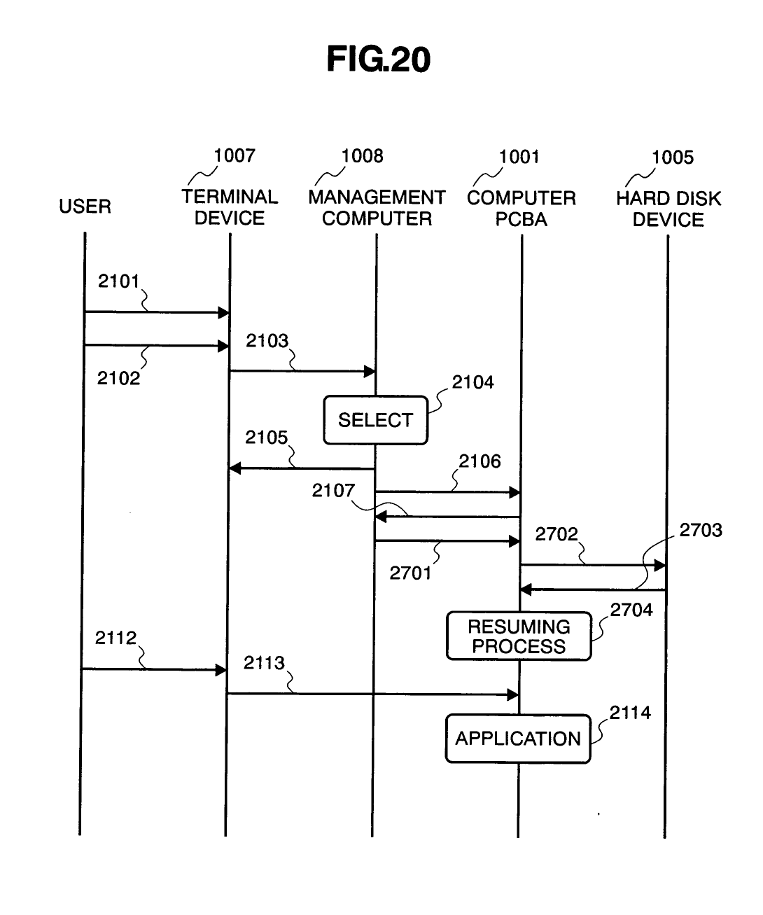

FIG. 20 is a diagram showing a procedure example that resumes the process from the hibernation mode. As in FIG. 14, the user requests the management computer 1008 to send the information on the computer PCBA 1001 to be started through the terminal device 1007 (Step 2103). The requested management computer selects the computer PCBA 1001 to be started. In the selecting process, since the hibernated user has been registered in the hibernated user list 1311, the management computer compares the information on the requesting user with the hibernated user list 1311, and selects the computer PCBA 1001 to be started. In this situation, the management computer 1008 rewrites the information on the running status of the table 1301 corresponding to the starting computer PCBA 1001 to “running”, and then deletes the information on the user that has been registered in the hibernated user list 1311 (Step 2104). Thereafter, the management computer 1008 notifies the terminal device 1007 of No. of the selected computer PCBA 1001. In this situation, in the case where the hibernated computer PCBA 1001 cannot be used for some reason, the management computer 1008 selects another computer PCBA 1001 as described above (Step 2105). In addition, the management computer 1008 instructs the power control mechanism 1003 to supply a power to the selected computer PCBA 1001, and starts the computer PCBA 1001 (Step 2106). The started computer PCBA 1001 transmits a BIOS sending request for reading out the OS over the network to the management computer 1008 (Step 2107).

The management computer 1008 that has received the BIOS sending request judges that the computer PCBA 1001 that has transmitted the BIOS sending request is a computer PCBA that is shifted from the hibernated state to the resume according to the computer PCBA No. included in the received request, and sends out the resume read BIOS to the computer PCBA 1001. The resume read BIOS does not read out a bootloader or OS from the storage area that has been allocated to the user, but allows the computer PCBA 1001 to execute the operation of reading out the operation information (memory image) of the computer PCBA 1001 which has been stored in the storage area at hibernation. It is possible that the normal operation and the process of resuming from the hibernation state are executed (Step 2701). The computer PCBA 1001 conducts a read request of data at an address which is occupied by the user from the hard disk device 1005 by using the BIOS (Step 2702). The hard disk device 1005 sends the data that is written by the computer PCBA 1001 to the computer PCBA 1001 at the time of shifting to the hibernation state according to the request (Step 2703). Thereafter, the computer PCBA 1001 conducts the resume process that returns all of data to the original (Step 2704). As a result, the computer PCBA 1001 becomes the same state as that at the time of shifting to the hibernation mode, and can continue the application process from this time (Step 2114).In the above-described embodiment, the on/off operation of the power of the computer PCBA 1001 is controlled according to whether the power control mechanism 1003 is supplying a power to the power line 1009, or not. However, it is possible that the power is always supplied to the computer device 1002, and the on/off operation or reset operation of the power to the respective computer PCBAs 1001 is conducted by using a power switch.

A backup server 1010 shown in FIG. 1 is a computer that backs up data that has been stored in the hard disk device 1005. The backup server 1010 has a storage medium such as an aggregative disk device like the hard disk device 1005, a tape changer, or an optical disk storage. The backup server 1010 is used to backup the data that has been stored in the hard disk device 1005 at appropriate time intervals by a manager. The provision of the backup server 1010 in the system makes it unnecessary that the users prepare the backup of the data that dispersedly exists on the computer PCBA 1001, individually. As a result, the manager can prepare the backup of the hard disk device 1005 in the backup server 1010 all at once. Consequently, it is possible that the operation (maintenance, etc.) to be conducted by the user or the manager is reduced, the convenience is improved, and the management costs of the manager are reduced.

### Second Embodiment

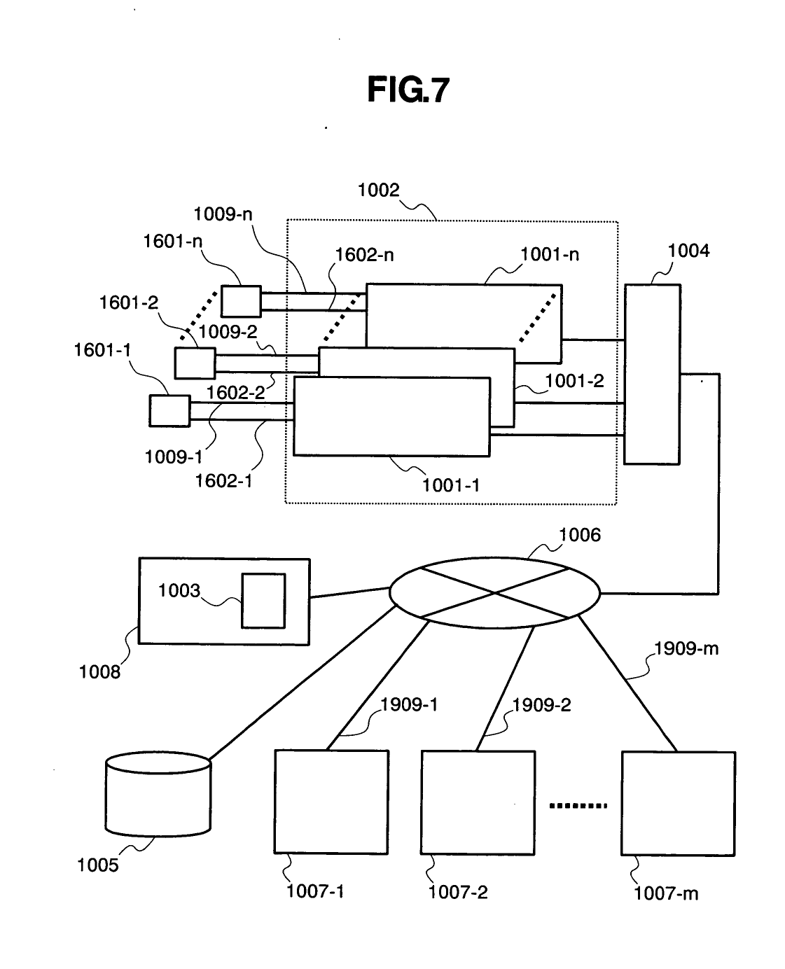

FIG. 7 is a diagram showing an example of a second embodiment. In this embodiment, the management computer 1008 directly instructs the computer PCBA 1001 to turn on the power supply whereas the power control mechanism 1003 and the management computer 1008 controls power-on to the computer PCBA 1001 in the first embodiment (FIG. 1). For that reason, the respective computer PCBAs 1001-1 to 1001-n are coupled to individual power supplies (1601-1 to 1601-n), respectively.

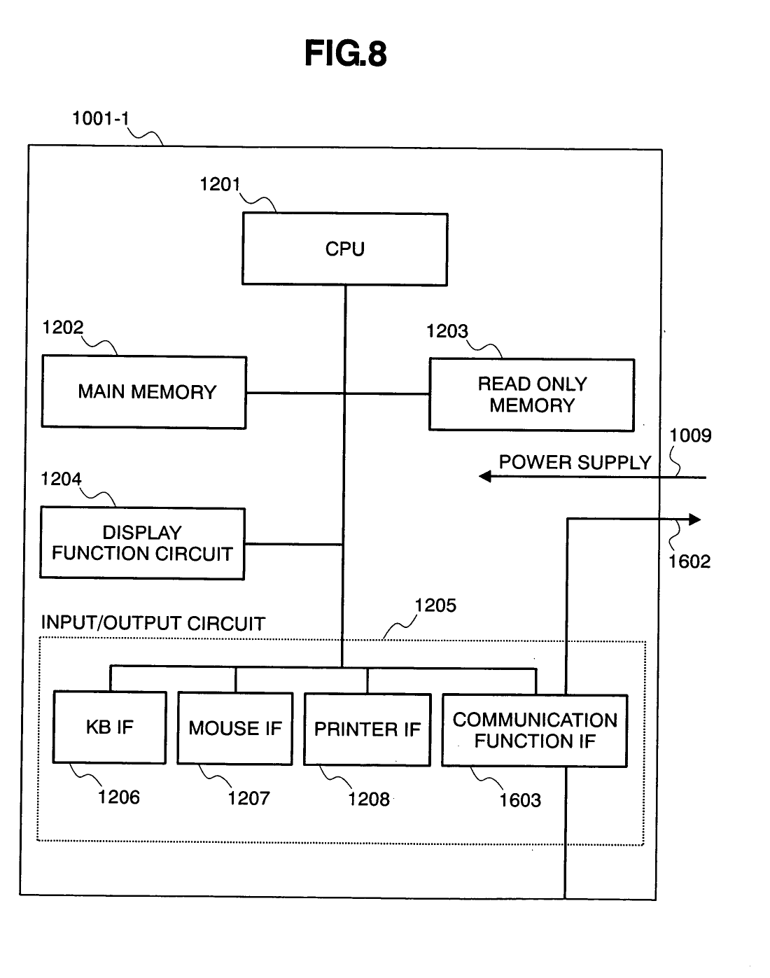

Specifically, the management computer 1008 instructs the computer PCBA 1001 to conduct power-on as a specific packet over the network 1006. FIG. 8 is a diagram showing a structural example of the computer PCBA 1001 that receives an instruction of power-on from the management computer 1008 in this embodiment. As compared with FIG. 2, this embodiment is different therefrom in that a communication function IF 1603 is coupled to a power control line 1602, and the power control line 1602 is coupled to an individual power supply 1601. Upon receiving a specific packet from the network 1006, a communication function interface 1603 in this embodiment controls the power control line 1602, and instructs the individual power supply 1601 to conduct power-on. The individual power supply 1601 that receives the instruction supplies a power to the corresponding computer PCBA 1001. As a result, the computer PCBA 1001 that has received the specific packet from the management computer 1008 starts. In this example, although the power supplies are separated, individually, in the above description, an integral power supply may be provided and supply a power to the respective computer PCBAs 1001-1 to 1001-n, individually. Also, the power supply may be doubled.

### Third Embodiment

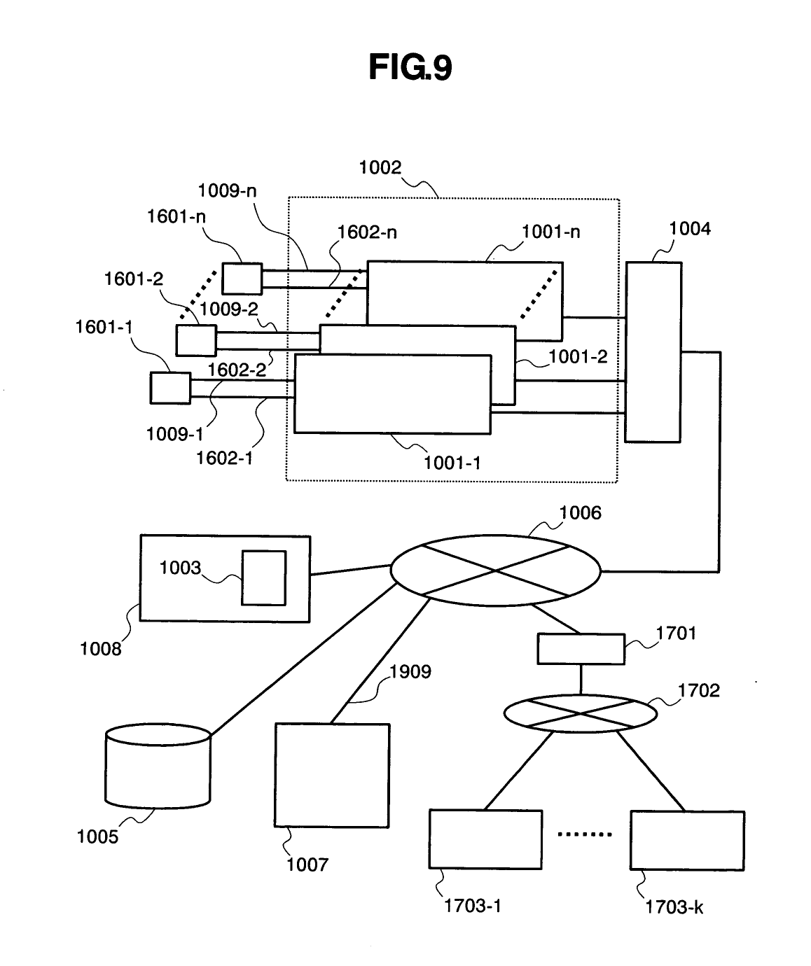

FIG. 9 is a diagram showing an example of a third embodiment.

In this embodiment, the computer PCBA 1001 is controlled from not only the terminal device 1007 but also a remote terminal device (1703-1 to 1703-k) over an internet 1702. In this embodiment, a firewall gateway 1701 is located at a node at which the internet 1702 is coupled to the network 1006. The network 1006 is a dedicated network for an enterprise which is generally called “internet”. In the case of connection from the internet 1702 outside of the enterprise, it is necessary to discriminate whether the user is correct, or not, at a gate, and the firewall gateway 1701 serves to conduct the above operation. In this embodiment, the firewall gateway 1701 determines whether the user who uses the remote terminal device 1703 is correct, or not, by means of the authentication information, and allows the internal network 1006 to be used by the remote terminal device 1703 only when the user is correct (authentication is successful).

### Fourth Embodiment

In this embodiment, a remote terminal device 1801 conducts a communication through a radio interface 1802. The radio interface 1802 is coupled to the internet 1702 through a base station 1803. According to this embodiment, the user can use the computer PCBA 1001 even during traveling moving. In this embodiment, the connection configuration used by the radio interface 1802 may be a radio connection using a cellular phone, or may be a connection configuration using a radio LAN.

The structure of the remote terminal devices 1703 and 1801 may be identical with the structure of the terminal device 1007. In that case, a communication function IF 1909 of the remote terminal device 1801 is an interface that is coupled to the radio interface 1802.

### Fifth Embodiment

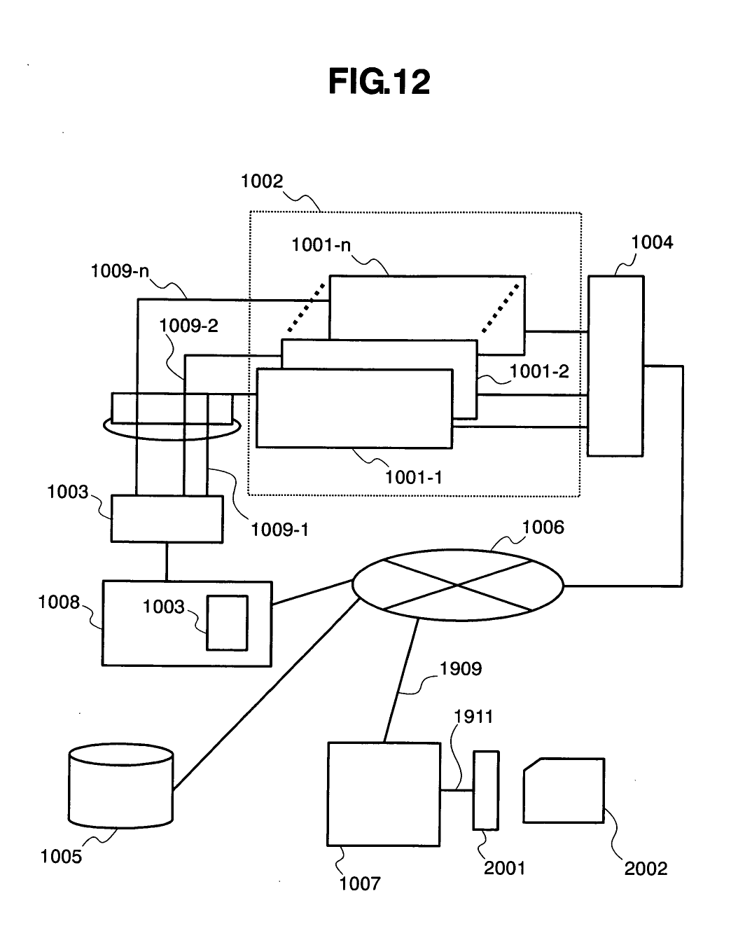

FIG. 12 is a diagram showing an example of a fifth embodiment.

In this embodiment, in the case where the terminal device 1007 shown in FIG. 1 is used by the user, an certification device 2002 is used for determining whether the user is a correct user (in the present specification, “correct” means that the use of the system is allowed by the manager in the system, or not) The terminal device 1007 uses a reader/writer 2001 in order to access to the certification device 2002. The reader/writer 2001 is coupled to the terminal device 1007 through the general-purpose I0 interface 1911. In this embodiment, the management computer 1008 conducts the user authentication using the certification device 2002, and allows the user to use the computer PCBA 1001 only when the correct user is connected. The reader/writer 2001 may be integrated with the reader/writer 2001.

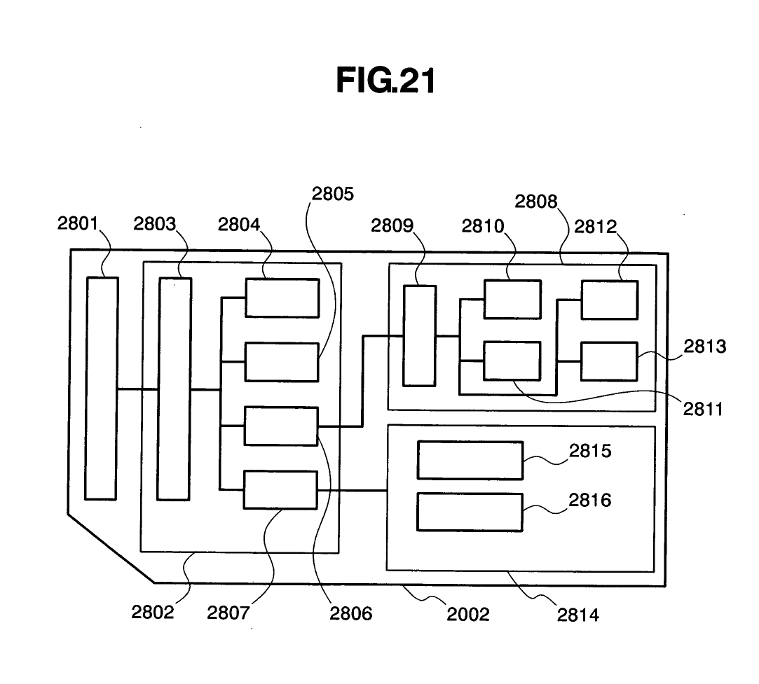

FIG. 21 is a diagram showing a structural example of the certification device 2002. A controller 2802, an IC card unit 2808 having a tamper resistant area, and a large capacity nonvolatile memory 2814 are installed in the certification device 2002. A process that requires security such as authentication is conducted by the IC card unit 2808. When a large capacity of data such as file data is going to be stored, a nonvolatile memory 2814 is used. The controller 2802 controls the use (particularly, choice) of the IC card unit 2802 and the nonvolatile memory 2814.

The certification device 2002 is coupled to the reader/writer 2001 through a terminal 2801, and a signal is delivered to the controller 2802 from the certification device 2002. The controller 2802 has a CPU 2804, a memory 2805, an IC card IF 2806, a nonvolatile memory IF 2807, and a card IF 2803. Those elements are mutually coupled to each other through an internal bus. The CPU 2804 determines whether the received command uses the nonvolatile memory, or uses the IC card unit, and then requests the IC card unit 2808 or the nonvolatile memory 2814 to conduct a command process through an appropriate interface.

The IC card unit 2808 has an interface 2809, a CPU 2810, a memory 2811, a cryptography processor 2812, and a nonvolatile memory 2813. Those elements are mutually coupled to each other via an internal bus. In the case of processing by the IC card unit 2808, for example, in the process of signature generating, the cryptography processor 2812 generates the signature data by using a private key that is stored in the nonvolatile memory 2813, and the CPU 2810 sends the sign data to the controller 2802 through the interface 2809.

In the case of using the nonvolatile memory 2814, the controller 2802 accesses to the nonvolatile memory as with the general file. For example, the controller 2802 accesses to communication software or library software 2816 that is stored as a data file in the nonvolatile memory 2814 as a file.

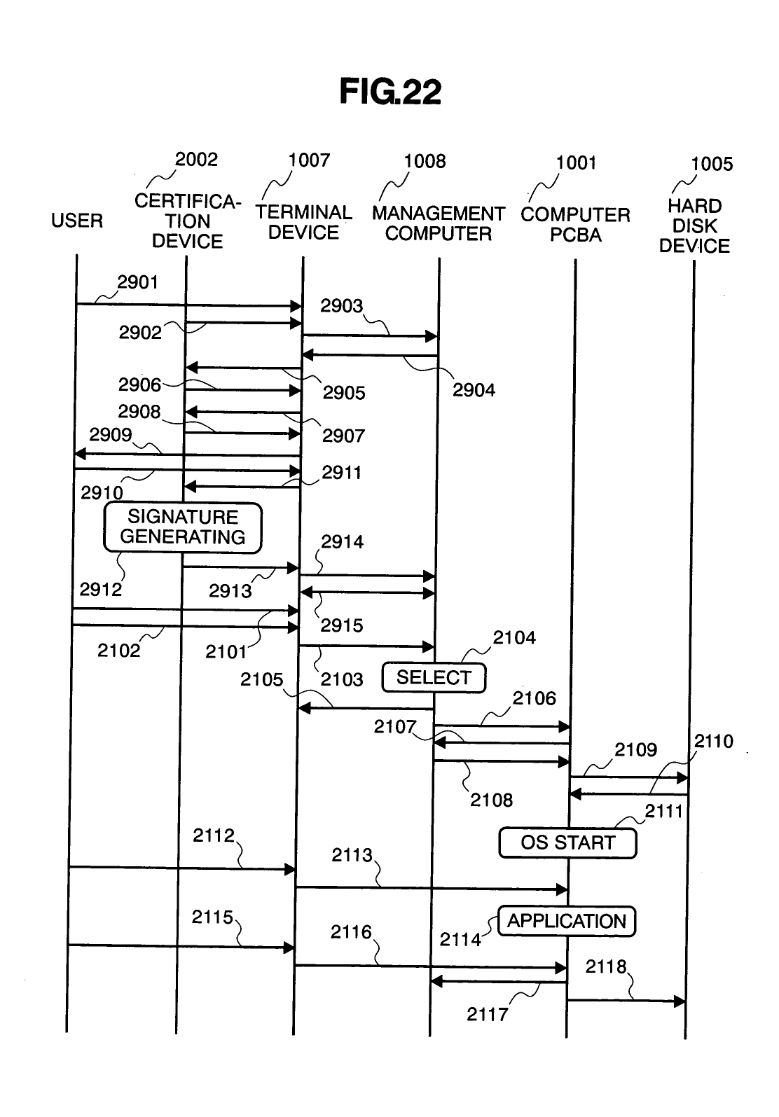

FIG. 22 is a diagram showing one example of user authentication procedure using the certification device 2002 in this embodiment. After the user has loaded the certification device 2002 into the reader/writer 2001, the user inputs a login request 2901 to the terminal device 1007 (Step 2901). In this situation, the terminal device 1007 reads the library software 2816 necessary for authentication from the nonvolatile memory 2814 of the certification device 2002 (Step 2902). The terminal device 1007 gives a login request to the management computer 1008 (Step 2903). The management computer 1008 that has received the login request returns an authentication information request to the terminal device 1007 (Step 2904). The terminal device 1007 that has received the authentication information request sends a certificate request to the certification device 2002 (Step 2905). The certification device 2002 that has received the certificate request reads the certificate that is stored in the nonvolatile memory 2813 of the IC card unit 2808 within the card, and then sends the certificate to the terminal device 1007 (Step 2906).

In addition, the terminal device 1007 issues a sign request to the certification device 2002 (Step 2907). Because the secret key that is stored in the IC card unit 2808 is used in the generating of the signature, the certification device 2002 returns the cryptography No. request for inquiring the licensing of the secret key to the terminal device 1007 (Step 2908). In order to permit the user to input the cryptography No. for using the secret key, the terminal device 1007 displays the cryptography No. request (Step 2909). The user inputs the cryptography No. (Step 2910). The terminal device 1007 transmits the inputted cryptography No. to the certification device 2002 (Step 2911). The certification device 2002 confirms the contents of the received cryptography No. and recognizes that the cryptography No. is correct. Thereafter, the certification device 2002 generates the signature by means of the cryptography processor 2813 within the IC card unit 2809 (Step 2912), and transmits the generated signature data to the terminal device 1007 (Step 2913). Thereafter, the terminal device 1007 implements a common key exchange 2915 with respect to the management computer 1008 by using the received sign data (Steps 2914 and 2915). As a result, the management computer authenticates that the user who uses the terminal device 1007 is right.

After completion of the common key exchange, the processes 2101 to 2118 are conducted by the user, the terminal device 1007, the management computer 1008, the computer PCBA 1001, and the hard disk device 1005, and the user conducts the application process on the computer PCBA 1001 and executes the completion process, as shown in FIG. 14 in the first embodiment.

In addition, while the application start process is conducted after the start process 2111 of the OS, the authentication operation may be conducted by using information such as the secret key inherent to the user and the user identifier which are stored in the IC card unit 2808 within the certification device 2002 in order to authenticate whether the user who uses the computer PCBA 1001 is right, or not.

That is, for example, the management computer 1008 compares the user identifier that is stored in the IC card unit 2808 within the certification device 2002 with the user identifier that has been registered in the user use area list shown in FIG. 5. If they are identical with each other, the management computer 1008 allocates the storage area of the storage device corresponding to the user identifiers. Also, in the case where the computer PCBA 1001 that is used by the user is predetermined in correspondence with the user identifier, the management computer 1008 allocates the computer PCBA 1001 corresponding to the user identifier.

That is, after the common key exchange has been completed, the user identifier in the case where the cryptography No. that has been transmitted by the step 2910 or the user identifier in the case where the user identifier is transmitted from the certification device 2002 in the step 2913 is transmitted to the management computer 1008 from the terminal device 1007 (Step 2103).

The management computer 1008 specifies the computer PCBA 1001 with reference to the predetermined user identifier and the table (FIG. 3) of the computer PCBA 1001 on the basis of the received user identifier (Step 2106). Then, the management computer 1008 transmits an address that specifies an area used by the user which is obtained with reference to the user identifier and the table (FIG. 5) of the storage device to the specified computer PCBA 1001 (Step 2106).

The computer PCBA 1001 starts the OS stored at the address on the basis of the transmitted address (Steps 2109 and 2110). When the OS starts, the user can execute the application.

According to this embodiment, the start of the OS by using the certification device 2002 and the authenticating operation using information such as the certificate or secret key inherent to the user which has been stored within the IC card unit 2808 are conducted, thereby making it possible to provide a computer system that is higher in the security than hat in the first embodiment. The terminal device 1007 may be integrated with the reader/writer.

### Sixth Embodiment

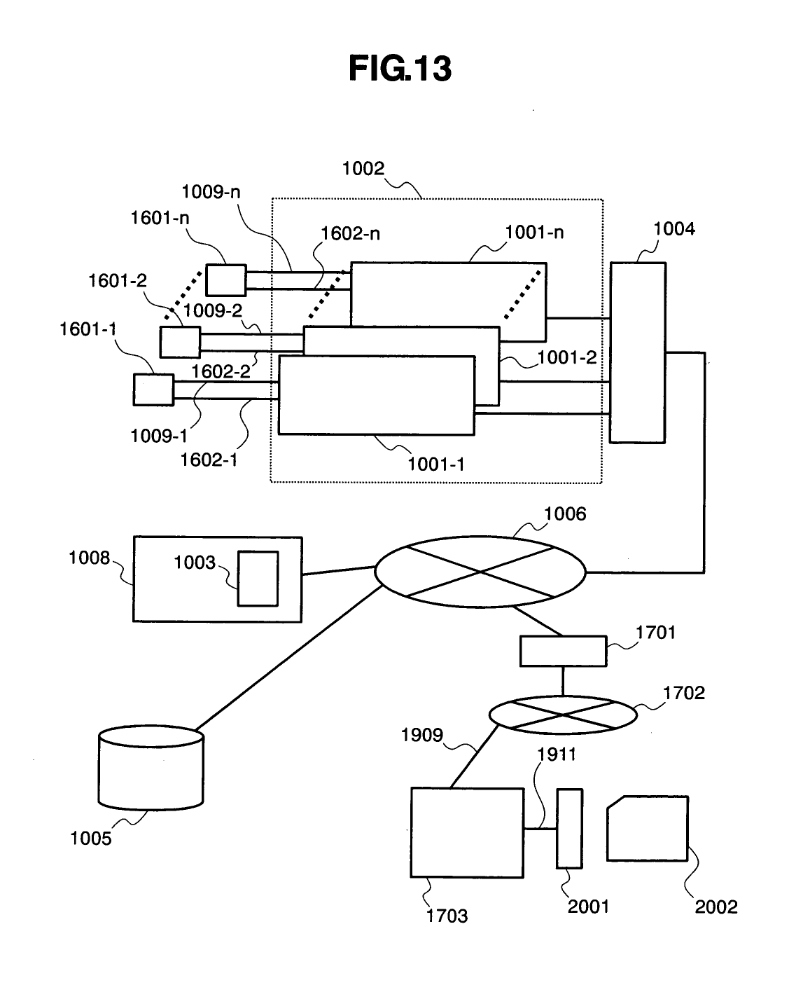

FIG. 13 is a diagram showing an example of a sixth embodiment.

In this embodiment, the certification device 2002 is used in order to judge whether the user is right, or not, when the user uses the remote terminal device 1703 shown in FIG. 9. The remote terminal device 1703 is coupled to the reader/writer 2001 for accessing to the certification device 2002 through the general purpose IO interface 1911. Different from the fifth embodiment, the user authentication using the certification device 2002 is conducted by not the management computer 1008 but the firewall gateway 1701. The procedure of the user authentication is identical with that described with reference to FIG. 22.

However, the process that is conducted by the management computer 1008 in FIG. 22 is executed by the firewall gateway 1701. Since the user is authenticated by the firewall gateway 1701, only the right user can be connected to the network 1006. The user authentication using the certification device 2002 may be further conducted in the management computer 1008 in addition to the user authentication in the firewall gateway 1701. As a result, not only the licensing of the network 1006 is authenticated, but also it can be authenticated whether the user is a right user who uses the computer PCBA 1001 that is managed by the management computer 1008, or not. The procedure of conducting the user authentication by using the certification device 2002 in both of the firewall gateway 1701 and the management computer 1008 is a procedure in which after the steps 2901 to 2915 shown in FIG. 22 have been executed by the user, the certification device 2002, the terminal device 1007, and the firewall gateway 1701, the steps 2901 to 2915 are further conducted by the user, the certification device 2002, the terminal device, and the management computer 1008.

### Seventh Embodiment

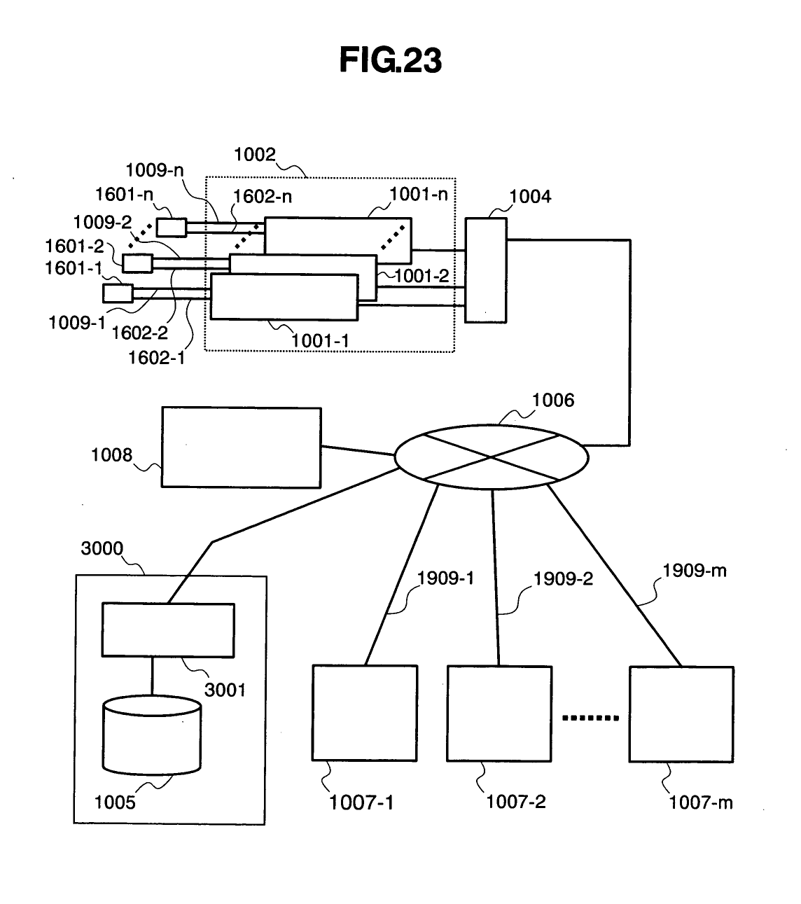

FIG. 23 is a diagram showing an example of a seventh embodiment.

In this embodiment, a storage device 3000 is equipped with the hard disk device 1005 built therein, and the storage device 3000 is applied to the system structure described with reference to FIG. 7. The storage device 3000 is equipped with an access right determination unit 3001 built therein that determines the right of an access to the hard disk device 1005 from the computer that is coupled to the network 1006. The control unit disposed in the hard disk device 1005 may determine the access right. In this case, the hard disk device 1005 is used as it is.

In this embodiment, the access right determination unit 3001 determines whether the computer PCBA 1001 (in fact, the user who uses the computer PCBA 1001) has been registered as a computer PCBA 1001 that is permitted to use the hard disk device 1005, or not, at a stage where the computer PCBA 1001 starts to access to the hard disk device 1005. Then, only when the computer PCBA 1001 has been registered, the computer PCBA 1001 can access to the hard disk device 1005.

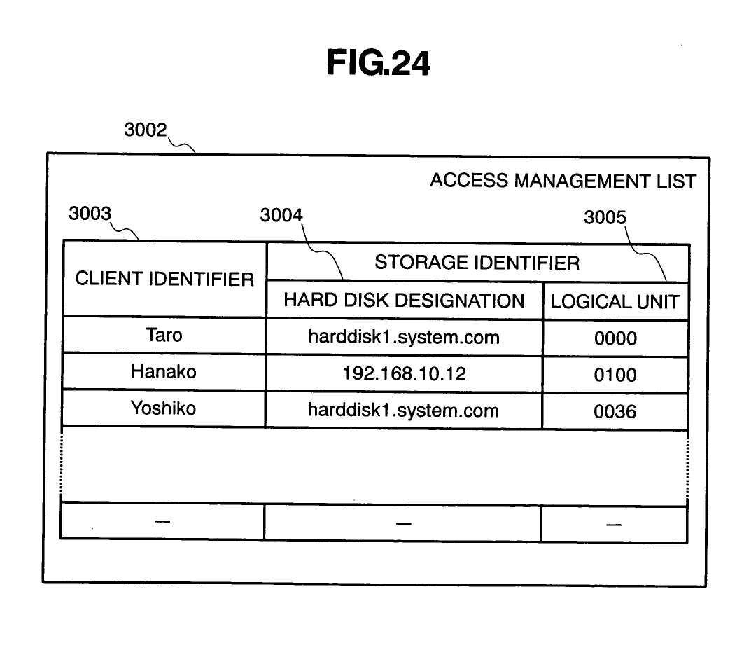

FIG. 24 is a diagram showing an example of an access management list 3002 which is stored in the access right determination unit 3001. The access right determination unit 3001 determines the computer PCBA 1001 that can access to the hard disk device 1005 on the basis of the information that has been registered in the access management list 3002. In the access management list 3002 is stored information on a correspondence between a client identifier 3003 that is given to the computer PCBA 1001 and storage identifiers (3004, 3005) that are given to the hard disk device 1005. Only the computer PCBA 1001 corresponding to the client identifier 3003 which has been registered in the access management list 3002 can access to the storage area within the hard disk device 1005 which is indicated by the storage identifier corresponding to the client identifier. The information that is registered in the access management list 3002 is inputted to the access right determination unit 1402 through the management computer 1008.

More specifically, the client identifier stores the information corresponding to the user name 1402 shown in FIG. 5 therein. The storage identifier is made up of the hard disk designation and the logical unit No., and stores the information corresponding to the hard disk designation 1403 and the logical unit No. 1404 shown in FIG. 5, respectively.

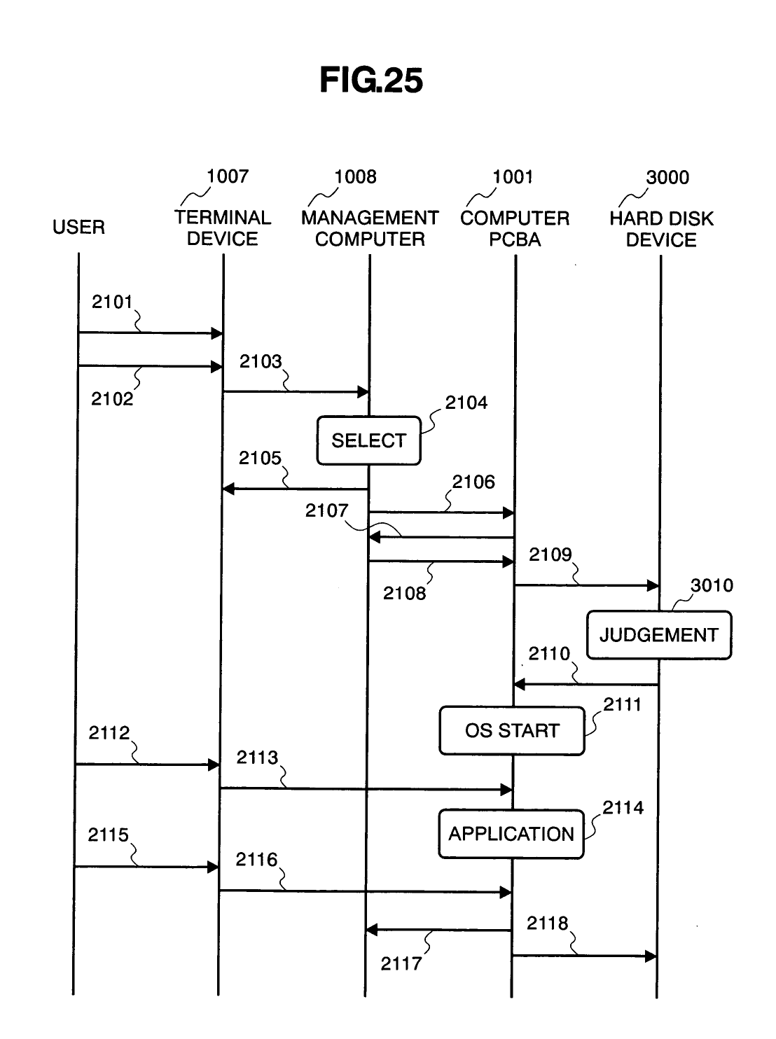

FIG. 25 is a diagram showing an example of a starting procedure in the case of using the storage device 3000. In this embodiment, a step 3010 conducted in the storage device 3000 is added to the procedure shown in FIG. 14. Through a sequential procedure according to a start request from the user, the computer PCBA 1001 conducts a data read request from the storage device 3000 by using the BIOS that has been transmitted from the management computer 1008 (Steps 2101 to 2109). In this situation, the computer PCBA 1001 transmits the information on the user name 1402 which has been transmitted together with the BIOS from the management computer 1008 to the storage device 3000 as the client identifier. In the storage device 3000, the access right determination unit 3001 determines whether the client identifier corresponding to the storage identifier of the accessed hard disk device 1005 coincides with the client identifier that has been transmitted from the computer PCBA 1001, or not, with reference to the access management list 3002 (Step 3010). In the case where information coincides with each other, the access right determination unit 3001 permits an access to The hard disk device 1005 as a computer that is allowed the computer PCBA 1001 which requested the access. In the subsequent operation, the user can conduct application on the computer PCBA 1001 through a continuous sequential process.

According to this embodiment, in the system configuration in which the plural computers access to the storage device through the network, because the storage device can check the right of the accessing computer in advance, an access from a false user can be eliminated, thereby being capable of providing a secure system.

### Eighth Embodiment

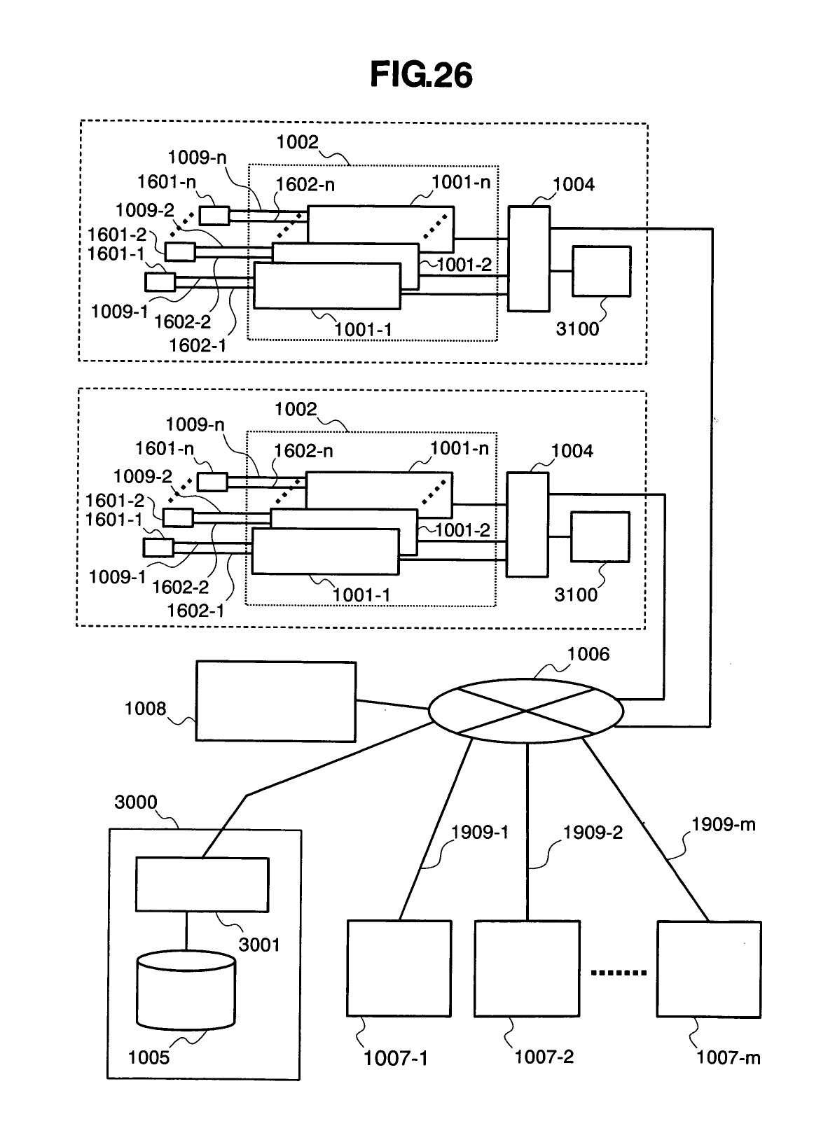

FIG. 26 shows an example of an eighth embodiment.

In the above-mentioned embodiment, in order to start the computer PCBA 1001, it is necessary that the computer PCBA 1001 per se acquires the BIOS for reading the OS through the network from the management computer 1008. However, as the number of computer PCBAs 1001 is more increased, a load on the network between the management computer 1008 and the computer PCBA 1001 is more increased. Under the circumstances, in this embodiment, in order to disperse the load on the network, the computer PCBAs 1001 that are coupled to the hub device 1004 are classified into plural groups, and a PCBA management computer 3100 that transmits the BIOS to each of the groups is installed. As a grouping method, there are a case in which plural hub devices 1004 are provided in each of the groups, and a case in which one hub device 1004 is theoretically divided into plural pieces through a VLAN to constitute the group. The computer. PCBA 1001 acquires the BIOS from the PCBA management computer 3100 that is coupled to the hub device 1004 (or VLAN) in the group to which the computer PCBA 1001 belongs.

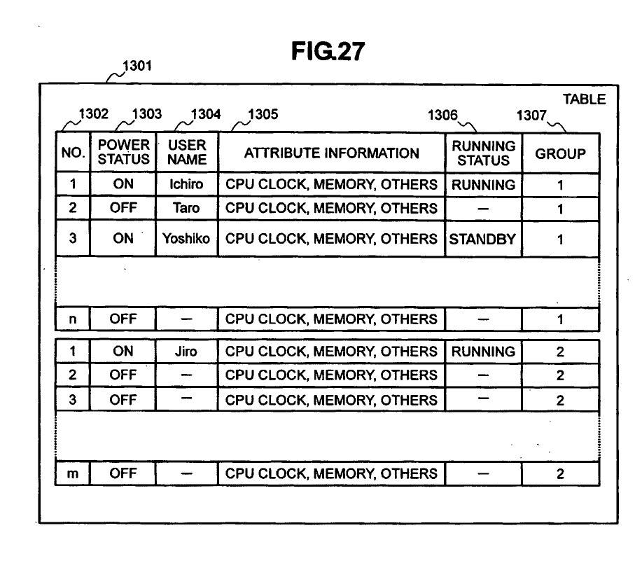

FIG. 27 is a diagram showing an example of the table 1301 which is stored in the management computer 1008 in order to implement this embodiment. As with the table 1301 shown in FIG. 3, the computer PCBA No. 1302, the power status 1303, the user name 1304, the attribute information 1305, and the running status 1307 are stored in the table 1301. In addition, the group No. 1307 to which the computer PCBA 1001 belongs is stored as information representative of a group to which the computer PCBA 1001 belongs. The computer PCBA 1001 is managed so as to determine a unique computer PCBA 1001 according to the combination of the group No. 1307 with the computer PCBA No. 1302 (that is, the computer PCBAs having the same No. may exist in the different group). Accordingly, even in other information (hibernated user list 1311) which is managed by the management computer 1008, the computer PCBA is managed by the combination of the computer PCBA No. with the group No. instead of the computer PCBA No.

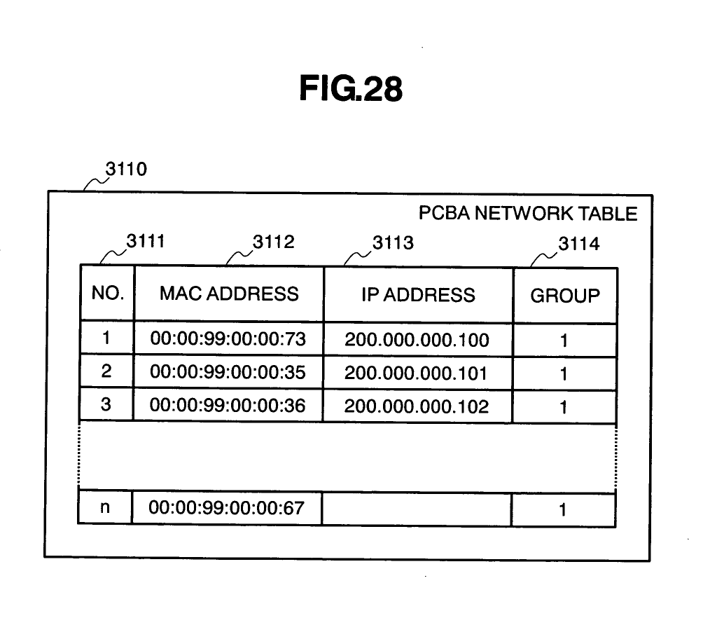

FIG. 28 is a diagram showing an example of a PCBA network table 3110 that stores the network information of the computer PCBA 1001 which is stored in the PCBA management computer 3100. In the PCBA network table 3110, there are stored a MAC address 3112 as the network information of the computer PCBA 1001, which corresponds to No. 3114 which is information representative of the group and No. 3111 representative of the computer PCBA 1001. Also, an IP address 3113 that is intended to be allocated to the computer PCBA 1001 is stored in the PCBA network table 3110.

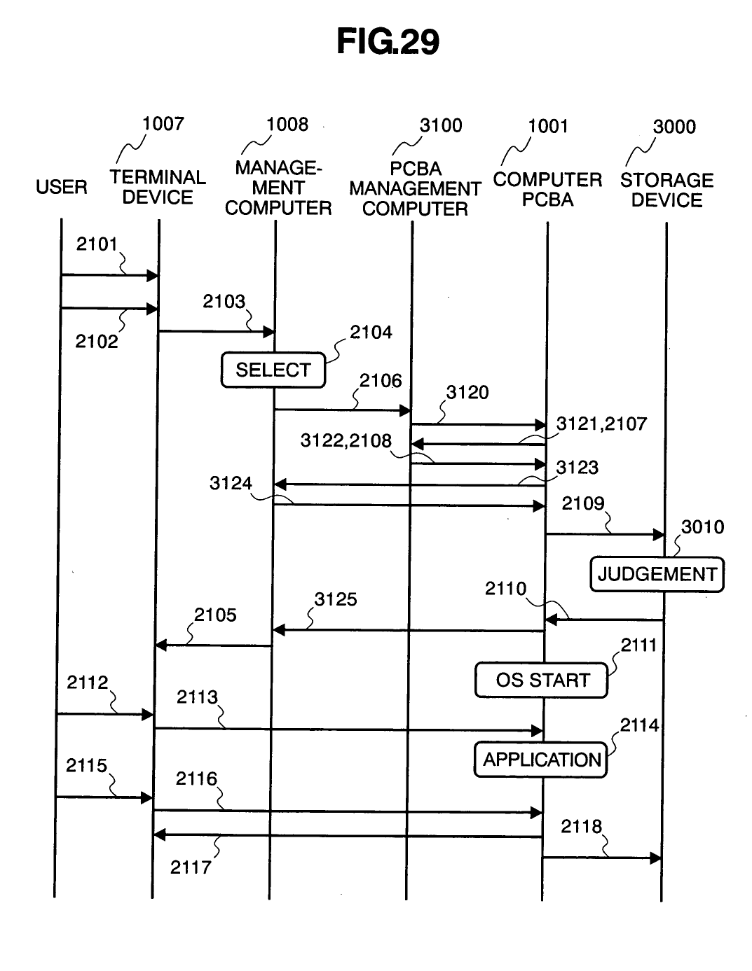

FIG. 29 is a diagram showing a procedure example of the starting process of the computer PCBA 1001 in the case of using the PCBA management computer 3100 in this embodiment. In the process shown in FIG. 29, steps 3120 to 31 are added to the procedure described with reference to FIG. 25 as a new procedure. Through a sequential procedure (Steps 2101 to 2104) according to a start request from the user, the management computer 1008 transmits the group No. 1307 and the PCBA No. 1302 of the selected computer PCBA 1001 to the PCBA management computer 3100 of the group to which the computer PCBA 1001 belongs in order to conduct power-on of the selected computer PCBA 1001 (Step 2106).

The PCBA management computer 3100 that has received the transmitted No. instructs the power-on of the computer PCBA 1001 corresponding to the PCBA No. 1302. As a specific method of power on, the method that is conducted by the management computer 1008 and the power control mechanism 1003 in the above-mentioned embodiment may be conducted by the PCBA management computer 3100 (Step 3120). The computer PCBA 1001 whose power is on transmits the MAC address of the communication function IF 1209 provided in the computer PCBA 1001 to the PCBA management computer 3100 in order to establish the network connection (Step 3121). The PCBA management computer 3100 that has received the MAC address of the computer PCBA 1001 transmits the IP address 3113 corresponding to the transmitted MAC address with reference to the PCBA network table 3110. Subsequently, the computer PCBA 1001 transmits the BIOS sending request for reading the OS over the network to the PCBA management computer 3100 by using the received IP address 3113 (Step 2107). The PCBA management computer 3100 transmits the group No. 1307 and the PCBA No. 1302 of the computer PCBA 1001 corresponding to the IP address 3113 to the computer PCBA 1001 together with the read BIOS (Step 2108).

The computer PCBA 1001 that has received the BIOS executes the BIOS. In order to obtain the information on the storage device, the computer PCBA 1001 then transmits the group No. 1307 and the PCBA No. 1302 of the computer PCBA 1001 to the management computer 1008 (Step 3123). The management computer 1008 reads the user name 1304 corresponding to the computer PCBA 1001 from the group No. 1307 and the PCBA No. 1302. Then, the management computer 1008 returns the information on the hard disk designation 1403 and the logical unit No. 1404 corresponding to the user name 1402 which coincides with the user name 1304 to the computer PCBA 1001 (Step 3124).

The computer PCBA 1001 uses the transmitted information as the client identifier 3004 and the storage identifiers (3004, 3005), and requests the storage device 3000 to read the data that has been stored in the storage area which is occupied by the computer PCBA 1001 (Step 2109). The storage device 3000 determines the access right (Step 3010). The computer PCBA 1001 notifies the management computer 1008 of the IP address of the communication function IF 1209 provided in the computer PCBA 1001 at the stage of starting an access to the storage device 3000 (Step 31). Then, the management computer 1008 notifies the terminal device 1007 of the IP address (Step 2105). The subsequent procedure is identical with that in FIG. 23, and the user can conduct the application on the computer PCBA 1001 through a continuous sequential process.

According to this embodiment, even if the number of computer PCBAs 1001 is increased, an increase in the network load due to the transmission of the read BIOS can be suppressed to a given amount, thereby being capable of providing a stably running system.

### Ninth Embodiment

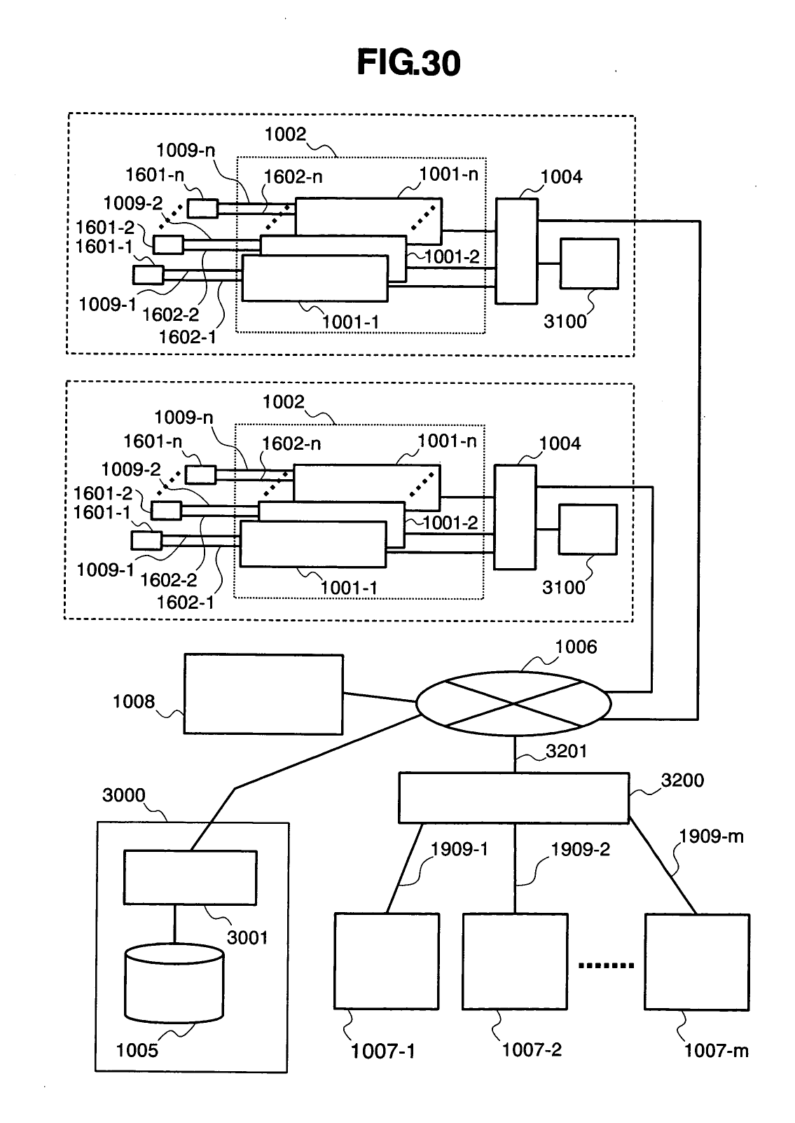

FIG. 30 is a diagram showing an example of a ninth embodiment.

In the above-mentioned embodiment, in order that the terminal device 1007 is coupled to the computer PCBA 1001 through the network, it is necessary to use network addresses (IP addresses) that have been allocated to the respective computer PCBAs 1001. In this embodiment, an application gateway device 3200 is located between the network connection 1909 that is coupled to the terminal device 1007 and the network 1006 to hold back the network address that has been allocated to the computer PCBA 1001 from the terminal device 1007. As a result, the security is enhanced.

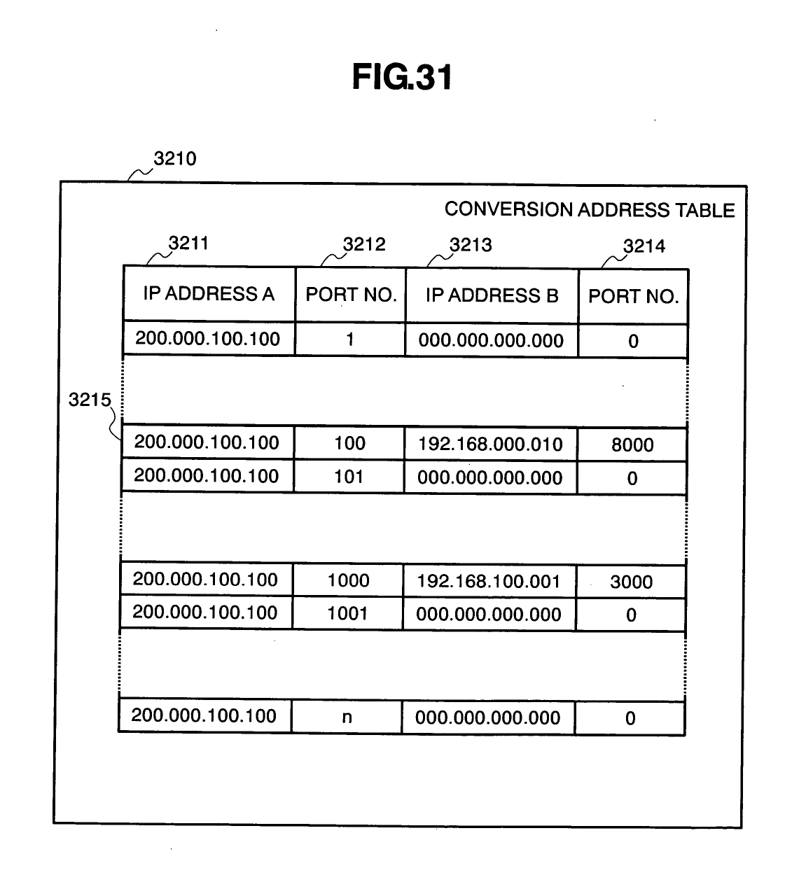

FIG. 31 is a diagram showing an example of a conversion address table 3210 which is stored in the application gateway device 3200. In the conversion address table 3210, the IP address A3211 that is allocated to the application gateway device 3200 and the connection port No. 3212, which are used when the terminal device 1007 is coupled to the application gateway device 3200 through the network connection 1909 are stored in association with the IP address B3213 that is used as the network address indicative of a transmitted address and the connection port No. 3214 when the application gateway device 3200 is coupled to a device coupled to the network 1006 through the network connection 3201.

In the case where the transmitted IP packet included in the packet that has been transmitted from the terminal device 1007 coincides with the IP address A3211, the application gateway device 3200 converts the transmitted IP address and the port No. included in the packet into the corresponding IP address B3213 and the port No. 3214. Then, the application gateway device 3200 transmits the converted packet to the network 1006.

Also, in the case where transmitting IP address included in the packet that has been received through the network 1006 coincides with the IP address B3213, the application gateway device 3200 converts the transmitting IP address and the port No. included in the packet into the corresponding IP address A3211 and the port No. 3212. Then, the application gateway device 3200 transmits the converted packet to the network connection 1909.

That is, the IP address at the side of the network connection 1909 of the application gateway device 3200 is set at the IP address A3211. The IP address of a device that is coupled to the network 1006 is set at the IP address B3213. With this arrangement, the device that is coupled to the network connection 1909 and the device that is coupled to the network 1006 can be coupled to each other over the network through the IP address of the application gateway device 3200. When the values of the IP address B3213 are “000.000.000.000”, the port No. 3212 is unused. A row 3215 is previously set with a value for connection of the terminal device 1007 with the management computer 1008 over the network.

The contents of the conversion address table 3210 of the application gateway device 3200 are registered through the management computer 1008 over the network.

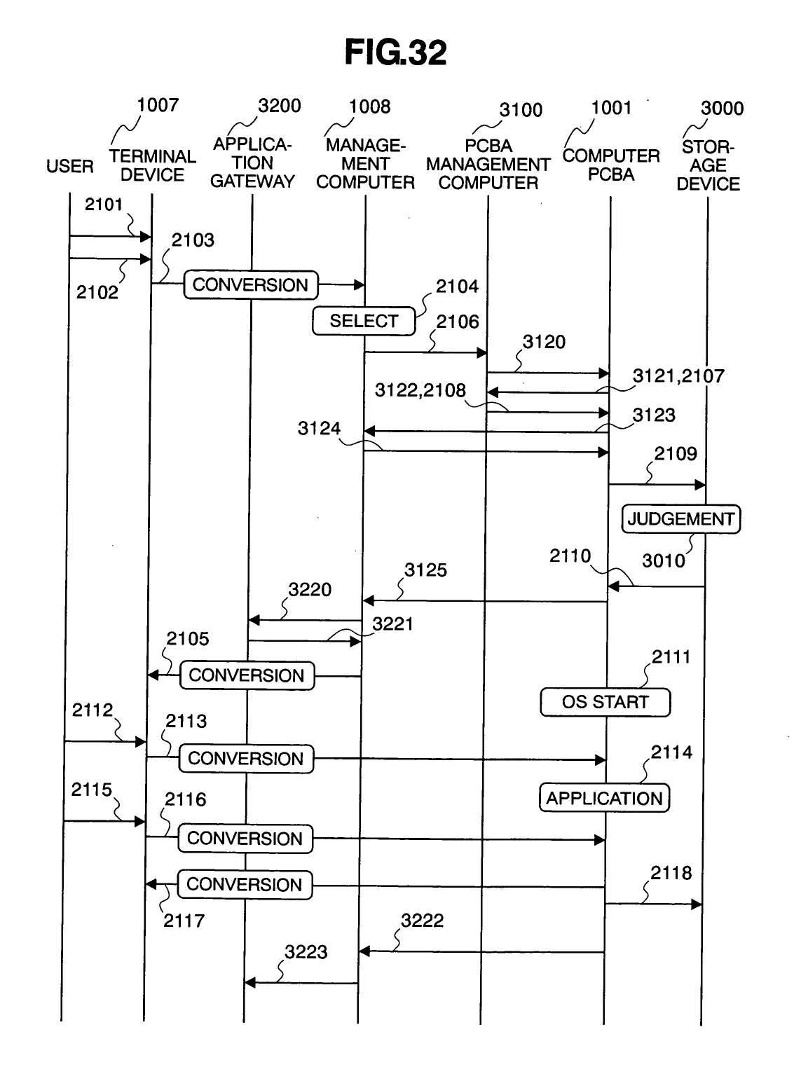

FIG. 32 is a diagram showing a procedure example of a starting process at the time of using the application gateway device 3200. In this embodiment, steps 3120 to 3223 are added to the procedure shown in FIG. 29 as a new procedure. In FIG. 32, all of communications (Steps 2103, 2105, 2113, 2116, and 2117) between the terminal device 1007 and a device that is coupled to the network 1006 pass through the application gateway device 3200. Specifically, a request from the terminal device 1007 is converted in the application gateway device 3200, and to the device coupled to the network 1006, the communication is made to seem like it is from the application gateway device 3200. More specifically, the above operation is realized by converting the IP address and the port No. according to the value of the conversion address table 3210 in the application gateway device 3200 as described above.

In addition, through a sequential procedure according to a start request from the user, the management computer 1008 receives the IP address of the computer PCBA per se from the computer PCBA 1001 (Steps 2101 to 2104, 2106 to 2110, 3010, and 3120 to 31). The management computer 1008 transmits the received IP address and information on a predetermined service port No. to the application gateway device 3200. Then, the management computer 1008 gives an allocation request of the new port No. 3212. The application gateway device 3200 seeks an unused row entry with reference to the conversion address table 3210. Then, the application gateway device 3200 writes the transmitted IP address and port No. at the IP address B3213 and the port No. 3214 in the entry, respectively. Then, the application gateway device 3200 returns the IP address A3211 and the port No. 3212 of the entry to the management computer 1008 (Step 3221). The management computer 1008 transmits the received IP address A3211 and port No. 3212 to the terminal device 1007 (Step 2105), and the terminal device 1007 can execute the application through the subsequent sequential procedure (Steps 2111 to 2118).

In the case where the computer PCBA 1001 stops, the computer PCBA 1001 transmits a stop notification to the management computer 1008 (Step 3222). The management computer 1008 transmits the received notification transmitting IP address to the application gateway device 3200 (Step 3223). The sequential procedure is completed by making the entry that coincides with the transmitted IP address in an unused state.

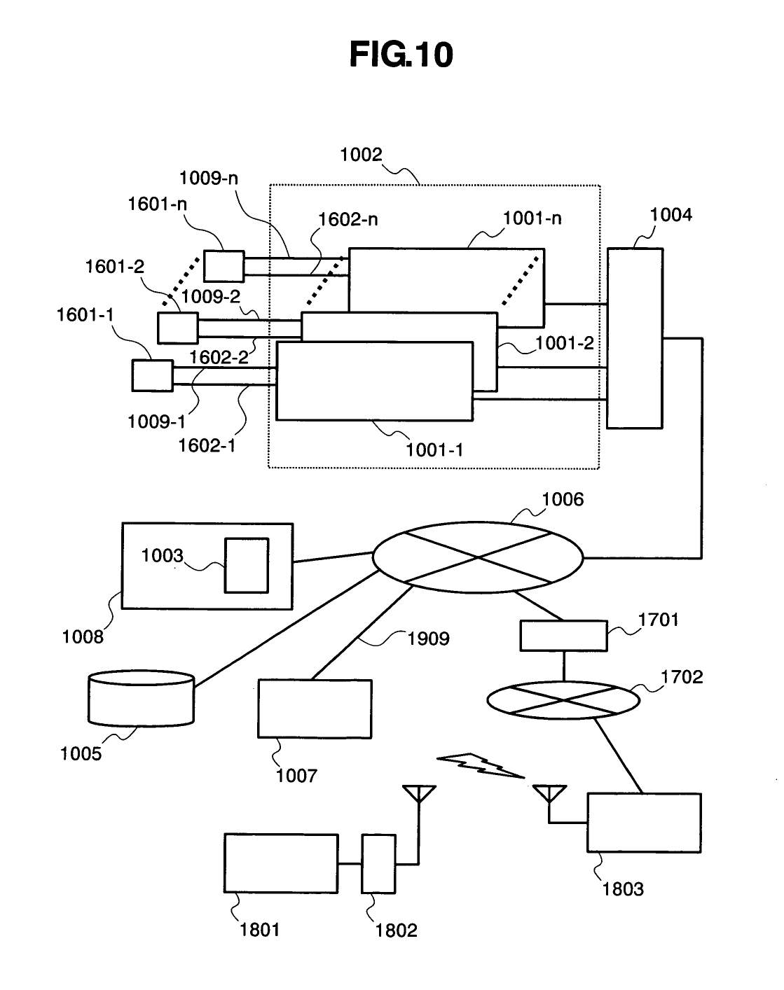

According to this embodiment, the application gateway device 3200 is located between the network connection 1909 that is coupled to the terminal device 1007 and the network 1006, to hold back the network address that has been allocated to the computer PCBA 1001 from the terminal device 1007. As a result, the security is enhanced. It is needless to say that this embodiment can be applied to a configuration of using the remote terminal device 1703 over the internet 1702 as shown in FIG. 9, and a configuration of using the remote terminal device 1801 through the radio interface 1802 as shown in FIG. 10.

Also, this embodiment can be applied to a case in which the certification device 2002 is used in order to determine whether the user is right, or not, when the user uses the terminal device 1007, as shown in FIG. 12.

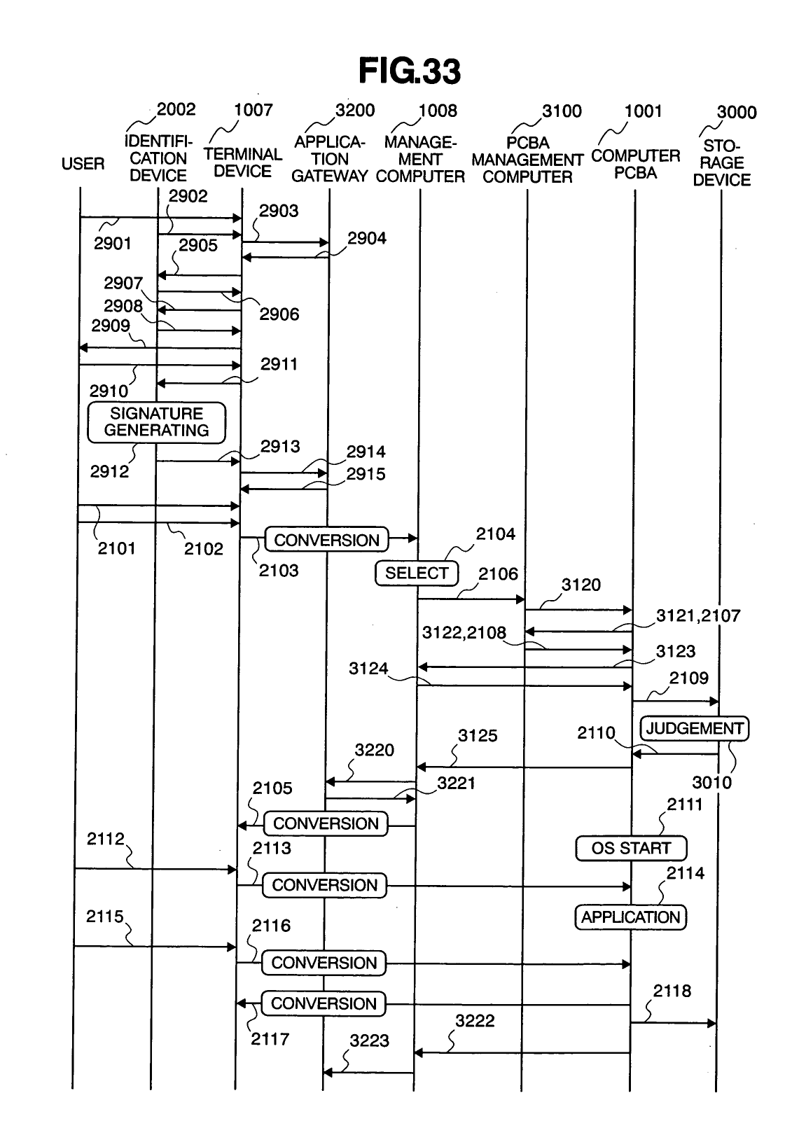

FIG. 33 is a diagram showing a procedure example of a starting process of the computer PCBA 1001 in the case of using the certification device 2002. In this procedure, the application gateway device 3200 executes the process that has been conducted by the management computer 1008 in the procedure described with reference to FIG. 22. The procedure after the common key exchange has been completed, that is, the procedure subsequent to the step 2101 is identical with the procedure shown in FIG. 32.

In addition, by combination of the above-mentioned embodiments, the user conducts authentication by using the certification device 2002 from the terminal device 1007. As a result, the management computer 1080 and the PCBA management computer 3100 are associated with each other. The OS and the business application program start with respect to the computer PCBA 1001 that has been allocated to the authenticated user by using the hard disk device within the storage device 3000 that has been allocated to the authenticated user. In addition, a communication path of the network connection between the terminal device 1007 that can be used by only the authenticated user and the computer PCBA 1001 the application gateway device 3200 is established, thereby making it possible to execute the user's application in a secure and stable state.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A computer system, comprising:
a computer device comprising a plurality of computer printed circuit board assemblies (PCBAs);
a storage device that has a plurality of storage areas, which is coupled to the computer device over a network;
a management computer that manages the computer device and the storage device; and
a terminal device that is coupled to the management computer over the network, wherein:
the management computer includes a first table that associates user information with the storage areas,
when a request for use including the user information is transmitted from the terminal device, the management computer selects an unused computer PCBA from the plurality of computer PCBAs, and returns a useable computer PCBA identification to the terminal device, and
the management computer allocates the storage area corresponding to the user information on the basis of the first table, and transmits an address that specifies the storage area to the computer device.

2-15. (canceled)

16. The computer system according to claim 1, wherein:
the management computer includes a another table that registers identifier information for acquiring licensing of a use area of the storage device, and
the selected computer PCBA acquires the identifier information that is stored in said another table from the management computer, and transmits the acquired identifier information to the storage device, and the storage device determines whether the received identifier information is right, or not, and when the storage device determines that the identifier information is right, the selected computer PCBA uses the use area of the storage device.

17. The computer system according to claim 1, wherein:
a second management computer that supplies a program for reading OS from the storage device to the computer PCBA is coupled over the network,
a computer PCBA whose power is on acquires the program for reading the OS from the second management computer, and
the program acquires the user information and information of the storage area which are registered in the first table from the management computer.

18. The computer system according to claim 1, further comprising a communication device that mediates a communication of the terminal device with the computer PCBA is coupled to the network to which the terminal device and the computer device are coupled, wherein:
the communication device acquires first network information for communicating with the computer PCBA that is selected by the management computer,
the terminal device acquires second network information for communicating with the selected computer PCBA through the communication device, and
the terminal device and the communication device communicate with each other by using the second network information, and then the communication device and the computer PCBA communicate with each other by using the first network information, and the communication between the terminal device and the computer PCBA is conducted through the communication device.

19-21. (canceled)

22. A computer system, comprising:
a computer device comprising a plurality of computer printed circuit board assemblies (PCBAs);
a plurality of terminal devices coupled to the each computer PCBA over a network;
a storage device that has a plurality of storage areas and coupled to the each computer PCBA over the network; and
a management computer that manages the one or more computer PCBAs and the storage device,
wherein the management computer:
(a) manages correspondence between user information and a storage area,
(b) selects a usable computer PCBA from the plurality of the computer PCBAs in response to a request for use of a computer PCBA including terminal device user information received from any one of the terminal devices,
(c) causes a start process of the selected computer PCBA to start, and
(d) notifies the one terminal device of information of the started computer PCBA and identification information on the network allocated to the started computer PCBA; and
wherein the selected computer PCBA retrieves information necessary for the start process from the storage area corresponding to the terminal device user information in the plurality of the storage areas of the storage device, and performs the start process based on the retrieved information.

23. The computer system according to claim 22, wherein the management computer:
predetermines correspondence between the user information and information specifying the selected computer PCBA, and
refers to the correspondence predetermined when selecting the computer PCBA.

24. The computer system according to claim 22, wherein the management computer:
manages correspondence among user information, information specifying the selected computer PCBA, and running information indicating whether the each computer PCBA is in a suspended mode,
searches the correspondence based on the user information included in the received request for use, and,
when a computer PCBA in the suspended mode is associated with the received user information, instructs the associated computer PCBA to return from the suspended mode.

25. The computer system according to claim 24, wherein the management computer updates the running information of the associated computer PCBA, with respect to the correspondence, according to a return process of the computer PCBA instructed to return.

26. The computer system according to claim 22, wherein the management computer:
(1) manages correspondence among user information, information specifying the selected computer PCBA, and running information indicating whether each computer PCBA is in a hibernation mode and
(2) manages whether each computer PCBA is in hibernation mode, and wherein the management computer determines, when receiving the request for use of a computer PCBA, whether the computer PCBA is usable, based on the correspondence, whether the each computer PCBA is in hibernation mode, and the user information included in the request for use.

27. The computer system according to claim 22, wherein the management computer:
manages whether each computer PCBA is suspended,
checks whether each computer PCBA is suspended, based on the user information included in the received request for use,
selects, when a suspended computer PCBA is associated with the user information received, the associated computer PCBA, and
controls the start process so that the selected computer PCBA performs a return process from the suspended state.

28. The computer system according to claim 25, wherein the management computer further:
manages correspondence among attribute information, running status, and user information of each computer PCBA; and
selects, by reference to the correspondence, another computer PCBA having attribute information the same as the attribute information of a computer PCBA selected before hibernation, when the computer PCBA associated with the user information received is not usable.

29. The computer system according to claim 28, wherein the management computer allocates, by reference to the correspondence, a computer PCBA having attribute information similar to the attribute information of the computer PCBA selected before the hibernation mode, when said another computer PCBA is not selectable.
